(19) United States
(12) Patent Application Publication
(10) Pub. No.: US 2017/0287438 A1
(43) Pub. Date: Oct. 5, 2017

(54) DISPLAY DEVICE

(71) Applicant: Japan Display Inc., Tokyo (JP)

(72) Inventors: Kojiro Ikeda, Tokyo (JP); Masaaki Kabe, Tokyo (JP); Akira Sakaigawa, Tokyo (JP)

(21) Appl. No.: 15/471,562

(22) Filed: Mar. 28, 2017

(30) Foreign Application Priority Data
Mar. 31, 2016 (JP) 2016-073036

(51) Int. Cl. G09G 5/10; G09G 3/20

(52) U.S. Cl. CPC G09G 5/10; G09G 3/2003; G09G 3/2092; G09G 3/2074; G09G 2300/0452

(57) ABSTRACT

According to an aspect, a display device includes: a display panel including a plurality of pixels; at least three of a first sub-pixel in a first color, a second sub-pixel in a second color, a third sub-pixel in a third color, and a fourth sub-pixel in a fourth color, the three sub-pixels being included in each of the pixels; and a controller configured to input an input signal to the first sub-pixel to the fourth sub-pixel. When display is performed in a plurality of display regions in respective single colors adjacent to each other in the display panel, the controller inputs a signal for lighting a sub-pixel that does not contribute to one of the single colors in a halftone manner, in a pixel included in a boundary section of the adjacent display regions.

### CROSS-REFERENCE TO RELATED APPLICATIONS

This application claims priority from Japanese Application No. 2016-073036, filed on Mar. 31, 2016, the contents of which are incorporated by reference herein in its entirety.

### BACKGROUND

### 1. Technical Field

The present invention relates to a display device.

### 2. Description of the Related Art

In recent years, there are increasing demands for display devices using a liquid crystal display panel or an organic electroluminescence display (OLED) panel using organic electroluminescence emission, as disclosed in Japanese Patent Application Laid-open Publication No. 2008-051905, for example. In a display device disclosed in Japanese Patent Application Laid-open Publications No. 2005-84513, No. 2005-316169, No. 2003-131653, and No. 2010-33014, one pixel includes a plurality of sub-pixels, and the sub-pixels output different colors of light. Combining the colors of the sub-pixels allows the one pixel to display various colors.

When display is performed in a plurality of display regions in respective single colors adjacent to each other, a black streak or a bright streak may appear in a boundary of the display regions. The streak appearing in the boundary is caused by a pixel array.

In the pixels in the boundary, a sub-pixel contributing to the display in the single color is lighted, but a sub-pixel not contributing to the display is unlighted. Therefore, in a case where the sub-pixels contributing to the display in the single color are separated from each other, an unlighted area is visually recognized as the black streak. On the other hand, in a case where the sub-pixels contributing to the display in the single colors are close to each other, to be specific, the sub-pixels are adjacent to each other, the different single colors are mixed with each other and are recognized as the bright streak.

For the foregoing reasons, there is a need for a display device that prevents the occurrence of the streaks in the display regions, thereby improving visibility of a display image.

### SUMMARY

According to an aspect, a display device includes: a display panel including a plurality of pixels; at least three of a first sub-pixel in a first color, a second sub-pixel in a second color, a third sub-pixel in a third color, and a fourth sub-pixel in a fourth color, the three sub-pixels being included in each of the pixels; and a controller configured to input an input signal to the first sub-pixel to the fourth sub-pixel. When display is performed in a plurality of display regions in respective single colors adjacent to each other in the display panel, the controller inputs a signal for lighting a sub-pixel that does not contribute to one of the single colors in a halftone manner, in a pixel included in a boundary section of the adjacent display regions.

### BRIEF DESCRIPTION OF THE DRAWINGS

FIG. 1 is a diagram illustrating a first embodiment;

FIG. 2 is a diagram illustrating the first embodiment;

FIG. 3 is a diagram illustrating the first embodiment;

FIG. 4 is a diagram illustrating the first embodiment;

FIG. 5 is a diagram illustrating the first embodiment;

FIG. 6 is a diagram illustrating the first embodiment;

FIG. 7 is a diagram illustrating the first embodiment;

FIG. 8 is a diagram illustrating the first embodiment;

FIG. 9 is a diagram illustrating the first embodiment;

FIG. 10 is a diagram illustrating the first embodiment;

FIGS. 11A and 11B are diagrams illustrating the first embodiment;

FIG. 12 is a diagram illustrating a first modification of the first embodiment;

FIGS. 13A and 13B are diagrams illustrating the first modification of the first embodiment;

FIG. 14 is a diagram illustrating a second modification of the first embodiment;

FIG. 15 is a diagram illustrating the second modification of the first embodiment;

FIG. 16 is a diagram illustrating a third modification of the first embodiment;

FIG. 17 is a diagram illustrating the third modification of the first embodiment;

FIG. 18 is a diagram illustrating a second embodiment;

FIG. 19 is a diagram illustrating the second embodiment;

FIG. 20 is a diagram illustrating a third embodiment;

FIG. 21 is a diagram illustrating the third embodiment;

FIG. 22 is a diagram illustrating a fourth embodiment;

FIG. 23 is a diagram illustrating the fourth embodiment;

FIG. 24 is a diagram illustrating a modification of the fourth embodiment;

FIG. 25 is a diagram illustrating a fifth embodiment;

FIG. 26 is a diagram illustrating the fifth embodiment;

FIG. 27 is a diagram illustrating a sixth embodiment;

FIG. 28 is a diagram illustrating the sixth embodiment;

FIG. 29 is a diagram illustrating the first embodiment;

FIG. 30 is a diagram illustrating a fourth modification of the first embodiment;

FIG. 31 is a diagram illustrating the fourth modification of the first embodiment; and

FIG. 32 is a diagram illustrating a modification of the fourth embodiment.

### DETAILED DESCRIPTION

The following describes embodiments of the present invention in detail with reference to the drawings. The disclosure is merely an example, and the present invention naturally encompasses appropriate modifications maintaining the gist of the invention that is easily conceivable by those skilled in the art. To further clarify the description, a width, a thickness, a shape, and the like of each component may be schematically illustrated in the drawings as compared with an actual aspect. However, this is merely an example and interpretation of the invention is not limited thereto. The same elements as those described in the drawings that have already been discussed are denoted by the same reference numerals throughout the description and the drawings, and detailed description thereof will not be repeated in some cases.

### First Embodiment

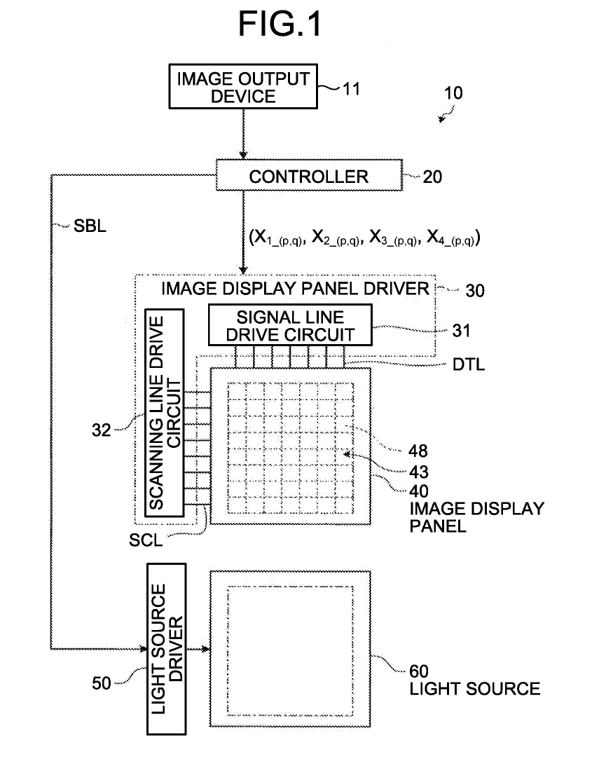

A first embodiment will be described with reference to FIGS. 1 to 11.

### Overall Configuration of Display Device

FIG. 1 is a block diagram illustrating an example of a configuration of a display device according to the first embodiment. As illustrated in FIG. 1, a display device 10 of the present embodiment includes a controller 20, an image display panel driver 30, an image display panel 40, a light source driver 50, and a light source 60. The controller 20 receives an input signal (RGB data) from an image output device 11, performs predetermined data conversion processing to the input signal, and sends a generated signal to each unit of the display device 10. The image display panel driver 30 controls driving of the image display panel 40 based on the signal from the controller 20. The light source driver 50 controls driving of the light source 60 based on the signal from the controller 20. The light source 60 illuminates the image display panel 40 from the back based on a signal from the light source driver 50. The image display panel 40 displays an image according to a signal from the image display panel driver 30 with the light from the light source 60.

### Configuration of Image Display Panel

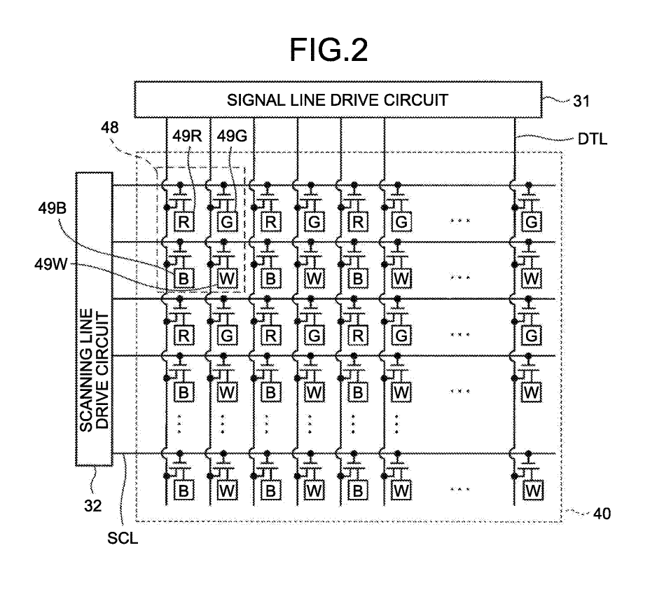

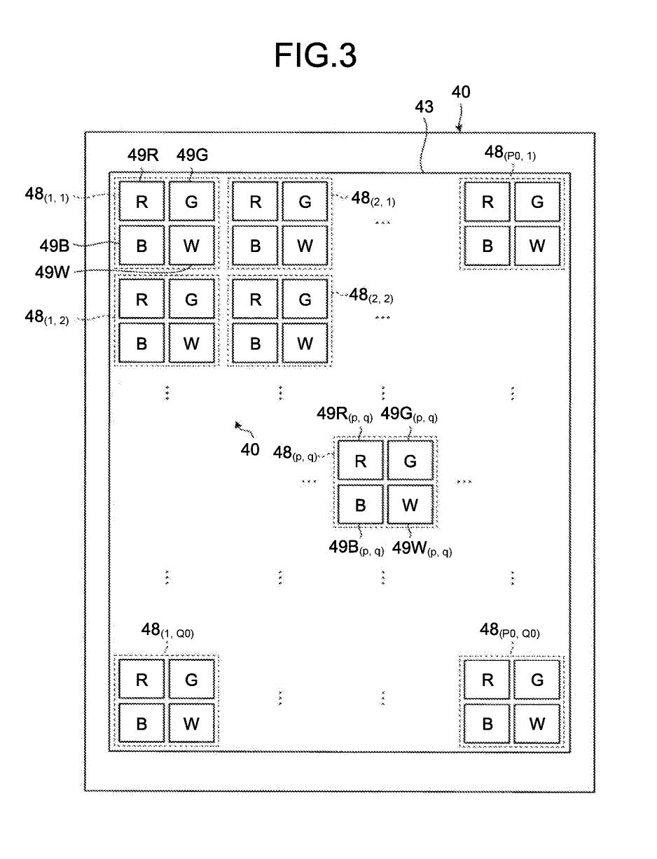

Next, a configuration of the image display panel 40 will be described. FIG. 2 is a conceptual diagram of the image display panel 40 according to the first embodiment. FIG. 3 is a schematic view illustrating an array of sub-pixels according to the first embodiment. As illustrated in FIGS. 1 to 3, the image display panel 40 includes a display panel 43 in which P₀×Q₀ pixels 48 are arrayed in a two-dimensional matrix manner in an X direction and a Y direction. The X direction is a row direction of an image displayed on the image display panel 40. The Y direction is a direction perpendicular to the X direction, and is a column direction of an image displayed on the image display panel 40. However, the present invention is not limited thereto, and the X direction may be the column direction of an image and the Y direction may be the row direction of an image.

As illustrated in FIGS. 2 and 3, the pixel 48 includes a first sub-pixel 49R, a second sub-pixel 49G, a third sub-pixel 49B, and a fourth sub-pixel 49W. The first sub-pixel 49R displays a first color (e.g., a first primary color such as red). The second sub-pixel 49G displays a second color (e.g., a second primary color such as green). The third sub-pixel 49B displays a third color (e.g., a third primary color such as blue). The fourth sub-pixel 49W displays a fourth color (e.g., white). The first color, the second color, the third color, and the fourth color are not limited to red, green, blue, and white, and may be complementary colors or the like as long as the colors are different from one another. The fourth sub-pixel 49W that displays the fourth color has preferably higher luminance than the first sub-pixel 49R that displays the first color, the second sub-pixel 49G that displays the second color, and the third sub-pixel 49B that displays the third color, when being irradiated with the same light amount from a light source. Hereinafter, when the first sub-pixel 49R, the second sub-pixel 49G, the third sub-pixel 49B, and the fourth sub-pixel 49W do not need to be distinguished from one another, these sub-pixels are referred to as sub-pixels 49. When positions where the sub-pixels are arrayed are distinguished and described, the fourth sub pixel of a pixel 48_{(p, q)} is described as a fourth sub-pixel 49W_{(p, q)}.

As illustrated in FIG. 3, the pixel 48 includes the four sub-pixels 49 arranged in two rows and two columns. The four sub-pixels 49 have the same shape and the same area. The four sub-pixels 49 are the first sub-pixel 49R, the second sub-pixel 49G, the third sub-pixel 49B, and the fourth sub-pixel 49W. In this way, the configuration in which the sub-pixels in two rows and two columns constitute one pixel is called a square pixel (SQ pixel) in the present embodiment. In the present embodiment, the first sub-pixel 49R, the second sub-pixel 49G, the third sub-pixel 49B, the fourth sub-pixel 49W are arranged at positions of upper left, upper right, lower left, and lower right, respectively, in the pixel 48.

### Configuration of Image Display Panel Driver

As illustrated in FIGS. 1 and 2, the image display panel driver 30 includes a signal line drive circuit 31 and a scanning line drive circuit 32. The image display panel driver 30 holds video signals (image information) by the signal line drive circuit 31, and sequentially outputs the video signals to the image display panel 40. To be specific, the signal line drive circuit 31 outputs an image output signal having a predetermined potential (gradation) according to an output signal from the controller 20 to the image display panel 40. The signal line drive circuit 31 is electrically coupled to the image display panel 40 by signal lines DTL. The scanning line drive circuit 32 controls ON and OFF of switching elements (e.g., thin film transistors (TFT)) for controlling operations (light transmittance) of the sub-pixels 49 in the image display panel 40. The scanning line drive circuit 32 is electrically coupled to the image display panel 40 by scanning lines SCL.

### Configurations of Light Source Driver and Light Source

The light source driver 50 controls the amount of light output from the light source 60. To be specific, the light source driver 50 controls the amount of light (intensity of light) to be emitted to the image display panel 40 by adjusting a voltage to be supplied to the light source 60 and the like by pulse width modulation (PWM) or the like based on a light source drive signal SBL output from the controller 20.

The light source 60 is arranged on the back or the front of the image display panel 40, and irradiates the image display panel 40 with light to illuminate the image display panel 40.

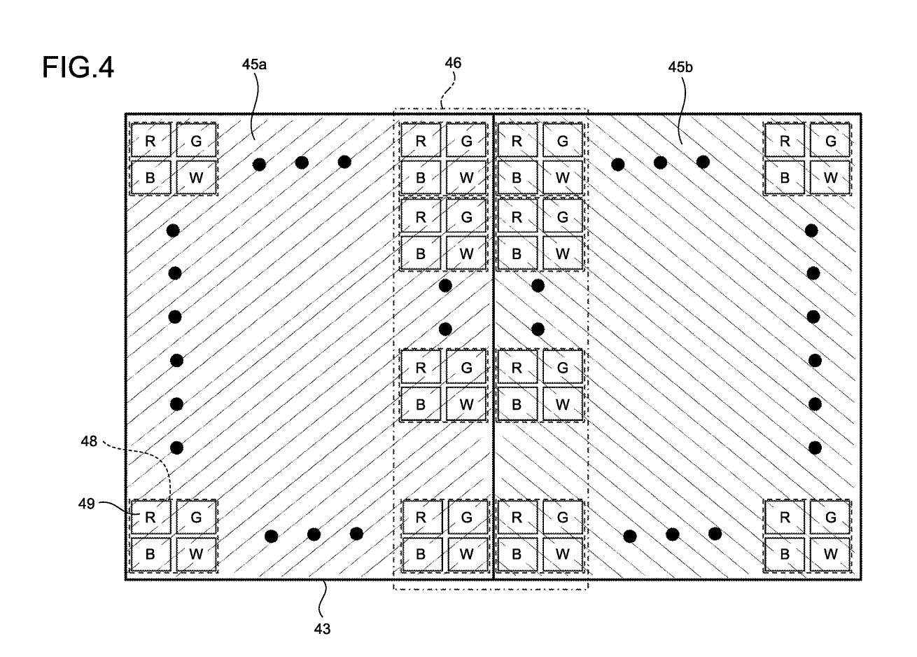

FIG. 4 illustrates an example in which display is performed in display regions 45a and 45b in different single colors laterally adjacent to each other in plan view in the display panel 43. In FIG. 4, for example, red is displayed in the display region 45a, and green is displayed in the display region 45b. In the present specification, in the plurality of display regions laterally adjacent to each other, pixel columns closest to the respective adjacent display regions are referred to as a boundary section 46.

In the present embodiment, an example is described in which display is performed in the display regions in different single colors laterally adjacent to each other in plan view. However, the present invention is not limited to the example. Display may be performed in the display regions in different single colors longitudinally adjacent to each other in plan view. In the case where the display regions are longitudinally adjacent to each other, pixel rows closest to the respective display regions are referred to as the boundary section 46.

Further, in the present embodiment, an example is described in which two display regions in single colors are adjacent to each other. However, the present embodiment may also employ an example in which three or more display regions in single colors are adjacent to one another. In other words, according to the present embodiment, the boundary section 46 of one of the display regions is on a pixel row or a pixel column closest to another one of the display regions adjacent and closest to the one of the display regions.

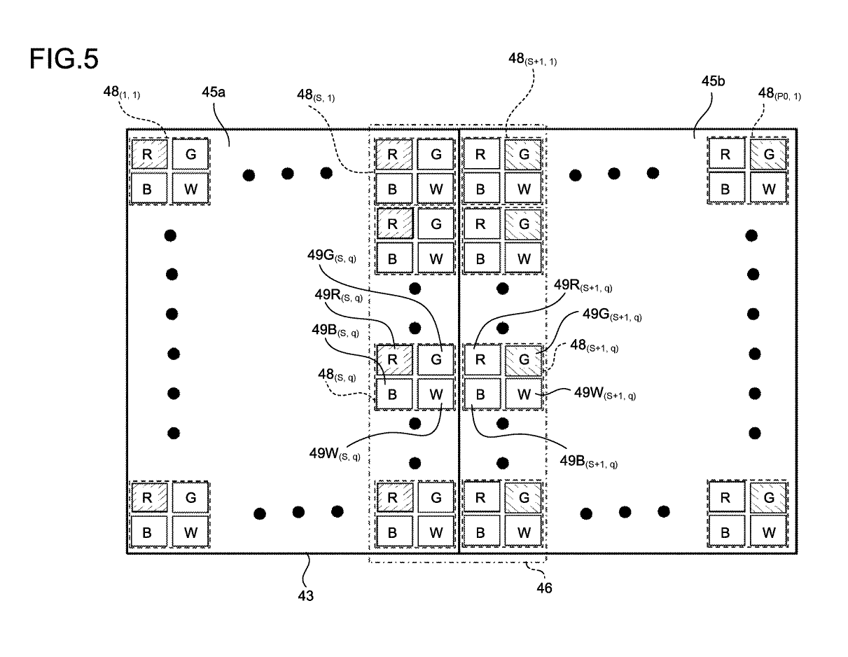

Assume that in the boundary section 46 of the display regions 45a and 45b, a pixel 48_{(S, q)} on an S-th column on the display region 45a side and a pixel 48_{(S+1, q)} on an (S+1)-th column on the display region 45b side are adjacent to each other (S is an integer of 1 or more, and (P₀−1) or less) (see FIG. 5). For example, on a q-th row of the boundary section 46, a first sub-pixel 49R_{(S, q)} of the pixel 48_{(S, q)} is lighted on the display region 45a side, and a second sub-pixel 49G_{(S+1, q)} of the pixel 48_{(S+1, q)} is lighted on the display region 45b side.

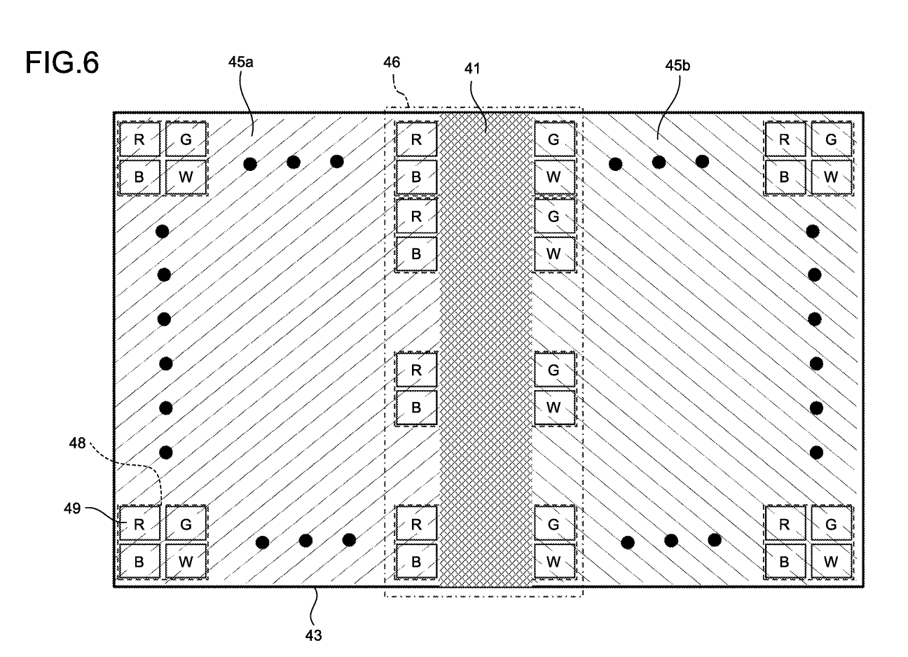

As illustrated in FIG. 5, a second sub-pixel 49G_{(S, q)} of the pixel 48_{(S, q)} and a first sub-pixel 49R_{(S+1, q)} of the pixel 48_{(S+1, q)} are arranged between the lighted first sub-pixel 49R_{(S, q)} of the pixel 48_{(S, q)} and the lighted second sub-pixel 49G_{(S+1, q)} of the pixel 48_{(S+1, q)}. The second sub-pixel 49G_{(S, q)} of the pixel 48_{(S, q)} and the first sub-pixel 49R_{(S+1, q)} of the pixel 48_{(S+1, q)}, which are arranged between the lighted sub-pixels 49, are unlighted. Further, a third sub-pixel 49B_{(S, q)} and a fourth sub-pixel 49W_{(S, q}) of the pixel 48_{(S, q}) and a third sub-pixel 49B_{(S+1, q)} and a fourth sub-pixel 49W_{(S+1, q)} of the pixel 48_{(S+1, q)} are also unlighted. These unlighted sub-pixels 49 may be visually recognized in the boundary section 46 where the different single colors are adjacent to each other, as a black streak 41 (see FIG. 6).

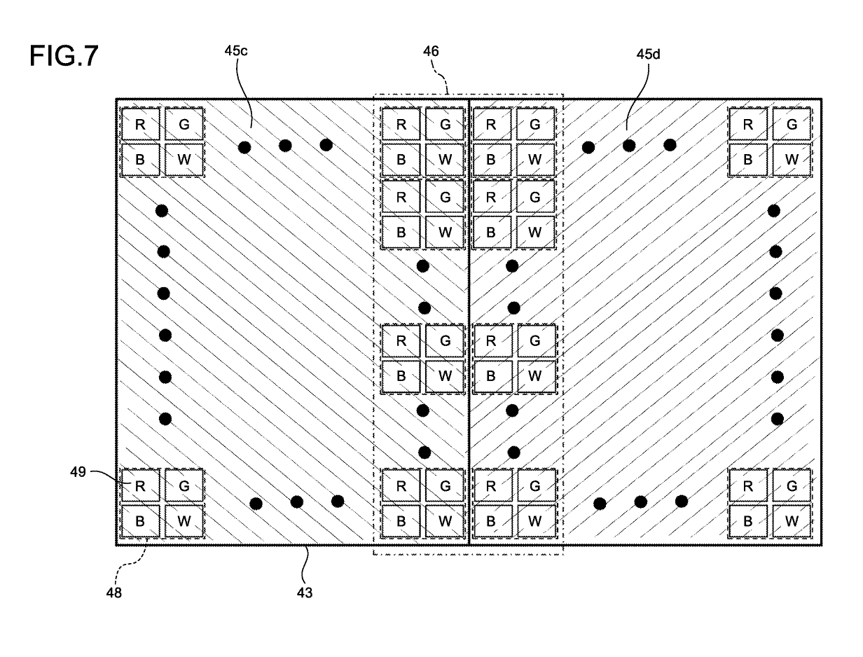

FIG. 7 illustrates an example in which in adjacent display regions 45c and 45d, green is displayed in the display region 45c, and red is displayed in the display region 45d, in an opposite manner to the example of FIG. 4.

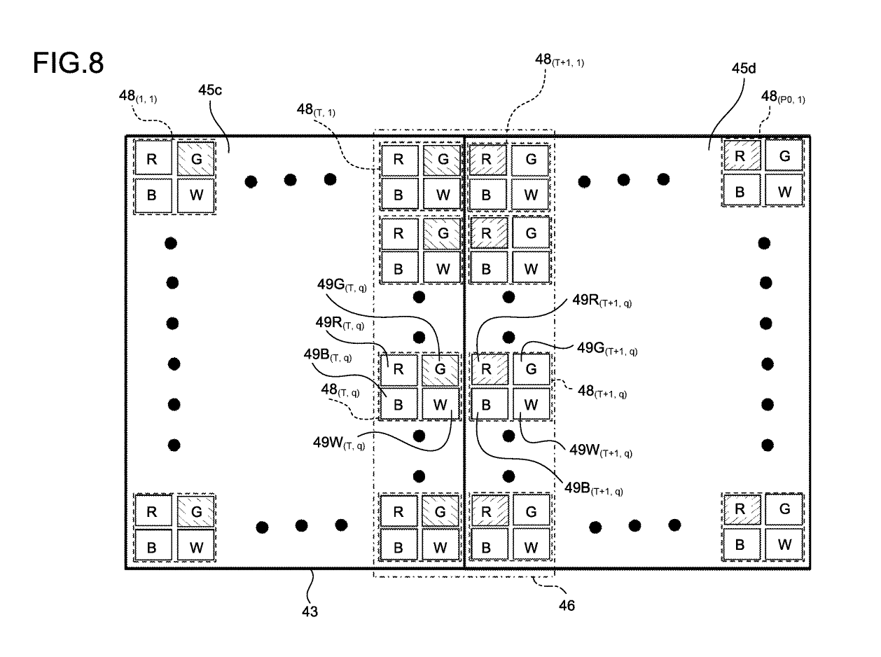

Assume that in the boundary section 46 of the display regions 45c and 45d, a pixel 48_{(T, q)} on a T-th column on the display region 45c side and a pixel 48_{(T+1, q)} on a (T+1)-th column on the display region 45d side are adjacent to each other (T is an integer of 1 or more, and (P₀−1) or less) (see FIG. 8). For example, on the q-th row of the boundary section 46, a second sub-pixel 49G_{(T, q}) of the pixel 48_{(T, q}) is lighted on the display region 45c side, and a first sub-pixel 49R_{(T+1, q)} of the pixel 48_{(T+1, q)} is lighted on the display region 45d side.

As illustrated in FIG. 8, the lighted second sub-pixel 49G_{(T, q)} of the pixel 48_{(T, q)} and the lighted second sub-pixel 49R_{(T+1, q)} of the pixel 48_{(T+1, q)} are arranged adjacent to each other. Further, the sub-pixels arranged adjacent to the lighted sub-pixels on the opposite side are unlighted. For example, in the case of the second sub-pixel 49G_{(T, q)} of the pixel 48_{(T, q)}, a first sub-pixel 49R_{(T, q)} of the pixel 48_{(T, q)} is unlighted. Similarly, in the case of the first sub-pixel 49R_{(T+1, q)} of the pixel 48_{(T+1, q)}, a second sub-pixel 49G_{(T+1, q)} of the pixel 48_{(T+1, q)} is unlighted. In this way, the sub-pixels 49 respectively adjacent to the lighted sub-pixels 49 adjacent to each other are unlighted, and thus the lighted sub-pixels 49 are emphasized.

The lighted sub-pixels 49 are in the respective single colors. Therefore, for example, when the red and green sub-pixels 49 are adjacently lighted, as described above, red and green are mixed with each other, and are visually and brightly recognized.

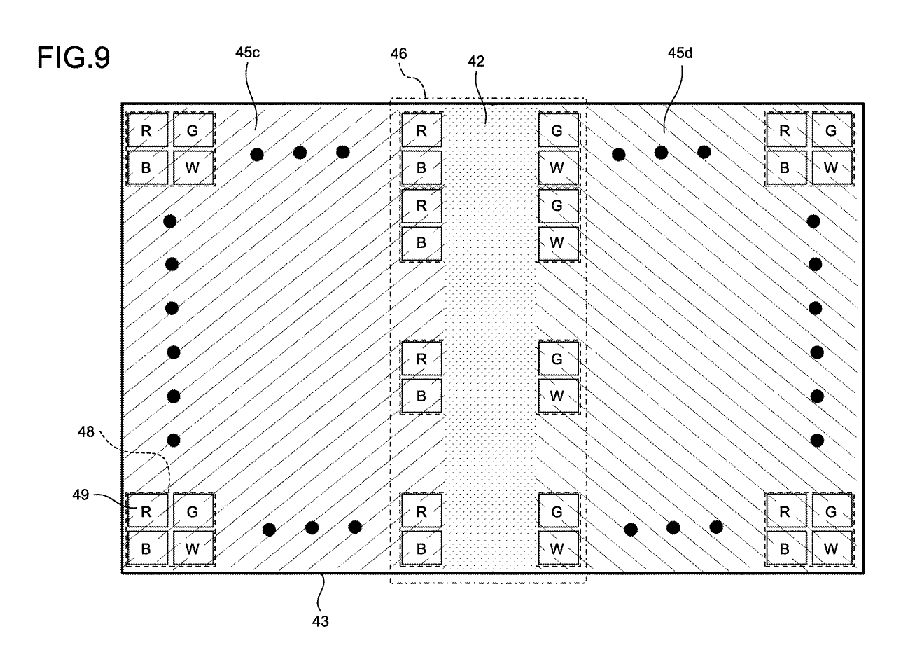

When the lighted sub-pixels 49 are adjacent to each other in this way, a bright streak 42 may be visually recognized in the boundary section 46 where the single colors are adjacent to each other (see FIG. 9).

In FIGS. 4 to 9, examples have been described in which display is performed in the display regions in red and green adjacent to each other. However, the streaks may occur in a case where any two of primary colors (red, green, and blue) having high gradation are displayed adjacently to each other, in a case where any two of complementary colors of the primary colors, i.e., any two of cyan (C), magenta (M), and yellow (Y) are displayed adjacently to each other, or in a case where any two colors that are complementary to each other are displayed adjacently to each other.

As described above, in the case where the display regions in different single colors are displayed adjacently to each other, the black streak occurs when the unlighted sub-pixels are arranged between the lighted sub-pixels, and the bright streak occurs when the lighted sub-pixels are adjacent to each other.

To prevent occurrence of the streaks, in the present embodiment, the sub-pixels not contributing to the single colors to be displayed are lighted in a halftone manner. Further, the sub-pixels contributing to the single colors to be displayed are also lighted in a halftone manner.

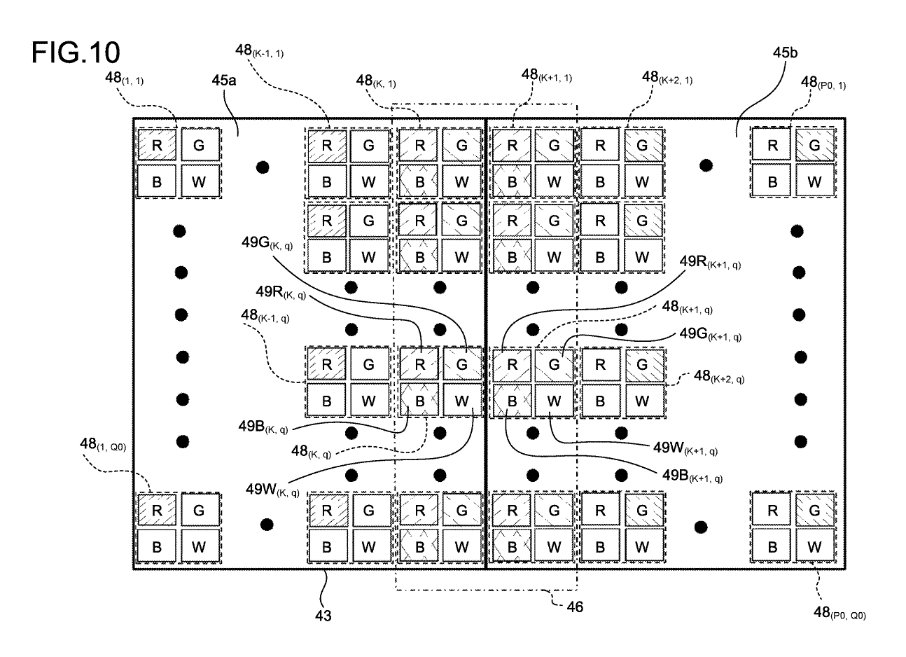

FIG. 10 illustrates an example in which the sub-pixels not contributing to the single colors to be displayed, that is, the sub-pixels that are originally supposed to be unlighted, among the sub-pixels in the boundary sections 46, are lighted in a halftone manner in the display device illustrated in FIGS. 4 to 6. In FIG. 10, assume that a pixel 48_{(K, q)} on a K-th column on the display region 45a side and a pixel 48_{(K+1, q)} on a (K+1)-th column on the display region 45b side are adjacent to each other in the boundary section 46 of the display regions 45a and 45b (K is an integer of 2 or more, and (P₀−2) or less).

For example, on the q-th row in the boundary section 46, a second sub-pixel 49G_{(K, q)} of the pixel 48_{(K, q)} on the display region 45a side, which is unlighted in FIG. 5, is lighted in a halftone manner. Further, a third sub-pixel 49B_{(K, q)} of the pixel 48_{(K, q)}, which is unlighted in FIG. 5, is lighted in a halftone manner.

A first sub-pixel 49R_{(K+1, q)} of the pixel 48_{(K+1, q)} on the display region 45b side, which is unlighted in FIG. 5, is lighted in a halftone manner. A third sub-pixel 49B_{(K+1, q)} of the pixel 48_{(K+1, q)}, which is unlighted in FIG. 5, is lighted in a halftone manner.

Further, a first sub-pixel 49R_{(K, q)} of the pixel 48_{(K, q)} on the display region 45a side, which is fully lighted to display red as the single color in FIG. 5, is lighted in a halftone manner. Meanwhile, a second sub-pixel 49G_{(K+1, q)} of the pixel 48_{(K+1, q)} on the display region 45b side, which is fully lighted to display green as the single color in FIG. 5, is lighted in a halftone manner.

That is, in the pixel 48_{(K, q)} and the pixel 48_{(K+1, q)} adjacent to each other in the boundary section 46, the second sub-pixel 49G_{(K, q)}, the third sub-pixel 49B_{(K, q)}, the first sub-pixel 49R_{(K+1, q)}, and the third sub-pixel 49B_{(K+1, q)}, which are originally supposed to be unlighted, are lighted in a halftone manner. Further, the first sub-pixel 49R_{(K, q)} and the second sub-pixel 49G_{(K+1, q)}, which are originally supposed to be fully lighted, are lighted in a halftone manner.

As described above, the sub-pixels 49 in the boundary section 46 are lighted in a halftone manner, and thus luminance change in the boundary section is reduced.

Meanwhile, the pixel 48 not included in the boundary section 46, for example, a pixel 48_{(K-1, q)} adjacent to the pixel 48_{(K, q)} in the display region 45a is lighted similarly to FIG. 5. That is, a first sub-pixel 49R_{(K-1, q)} of the pixel 48_{(K-1, q)} is fully lighted, and a second sub-pixel 49G_{(K-1, q)} and a third sub-pixel 49B_{(K-1, q)} are unlighted. Similarly, in the display region 45b, a pixel 48_{(K+2, q)} adjacent to the pixel 48_{(K+1, q)} is lighted similarly to FIG. 5. That is, a second sub-pixel 49G_{(K+2, q)} of the pixel 48_{(K+2, q)} is fully lighted, and a first sub-pixel 49R_{(K+2, q)} and a third sub-pixel 49B_{(K+2, q)} are unlighted.

The luminance change is reduced between the pixel 48 in the boundary section 46, and the pixel 48 that is not included in the boundary section 46 and that is adjacent to the boundary section 46. For example, in the display region 45a, between the pixel 48_{(K, q)} in the boundary section 46 and the pixel 48_{(K-1, q)} adjacent to the pixel 48_{(K, q)}, the pixel 48_{(K, q)} is lighted in a halftone manner, and the pixel 48_{(K-1, q)} is lighted in the single color. To be more specific, the first sub-pixel 49R_{(K, q)} of the pixel 48_{(K, q)} is lighted in a halftone manner, and the second sub-pixel 49G_{(K-1, q)} of the pixel 48_{(K-1, q)} is unlighted. The adjacent first sub-pixel 49R_{(K, q)} and second sub-pixel 49G_{(K-1, q)} are lighted in a halftone manner and unlighted, respectively, and thus the luminance change is gradual.

In FIG. 10, none of the fourth sub-pixels 49W is lighted.

Accordingly, the luminance change in the boundary section 46, and the luminance change between the boundary section and the display regions other than the boundary section is reduced, and the black streak is less likely to be visually recognized.

In this way, the unlighted sub-pixels are lighted in a halftone manner, and the fully lighted sub-pixels are lighted in a halftone manner, and therefore the luminance change is reduced, which prevents visual recognition of the streak. As described above, the visibility of a display image can be improved.

A method of lighting the sub-pixel in a halftone manner will be described below. To turn on the sub-pixel 49 in the pixel 48 in a halftone manner, sub-pixel rendering processing is performed. The sub-pixel rendering processing is processing to perform drive and displaying a sub-pixel unit, and change input signals of the sub-pixels 49 belonging to the same pixel 48. Hereinafter, the sub-pixel rendering processing is described as rendering processing as appropriate.

Input signals are input from the controller 20 to the pixels of the image display panel 40 through the image display panel driver 30. To be specific, signals are input from the controller 20 to the image display panel driver 30 with respect to the (p, q)-th pixel 48_{(p, q)} (1≦p≦P₀, and 1≦q≦Q₀), the signals including an input signal of a first sub-pixel 49R_{(p, q)} with a signal value of X₁_{_}_{(p, q)}, an input signal of a second sub-pixel 49G_{(p, q)} with a signal value of X₂_{_}_{(p, q)}, and an input signal of a third sub-pixel 49B_{(p, q)} with a signal value of X₃_{_}_{(p, q)}. Further, a signal including the input signal of a fourth sub-pixel 49W_{p, q)} with a signal value of X_{4-(p, q)} is input to the image display panel driver 30.

The input signal of the first sub-pixel 49R_{(p, q)} is a signal for displaying the first color (red, for example) in the first sub-pixel 49R_{(p, q)}. The input signal of the second sub-pixel 49G_{(p, q)} is a signal for displaying the second color (green, for example) in the second sub-pixel 49G_{(p, q)}. The input signal of the third sub-pixel 49B_{(p, q)} is a signal for displaying the third color (blue, for example) in the third sub-pixel 49B_{(p, q)}. The input signal of the fourth sub-pixel 49W_{(p, q)} is a signal for displaying the fourth color (white, for example) in the fourth sub-pixel 49W_{(p, q)}.

The input signals output from the controller 20 and input to the image display panel driver 30 are further output from the image display panel driver 30 and input to the pixels of the image display panel 40. The signal values of the input signals to the image display panel driver 30 may be changed when the signals are processed in and output from the image display panel driver 30. Assume that the signal value of the input signal to be input to the first sub-pixel 49R_{(p, q)} is an input signal value x₁_{_}_{(p, q)}. Similarly, assume that the signal value of the input signal of the second sub-pixel 49G_{(p, q)} is an input signal value x₂_{_}_{(p, q)}, the signal value of the input signal of the third sub-pixel 49B_{(p, q)} is an input signal value x₃_{_}_{(p, q)}, and the signal value of the input signal of the fourth sub-pixel 49W_{(p, q)} is an input signal value x₄_{_}_{(p, q)}.

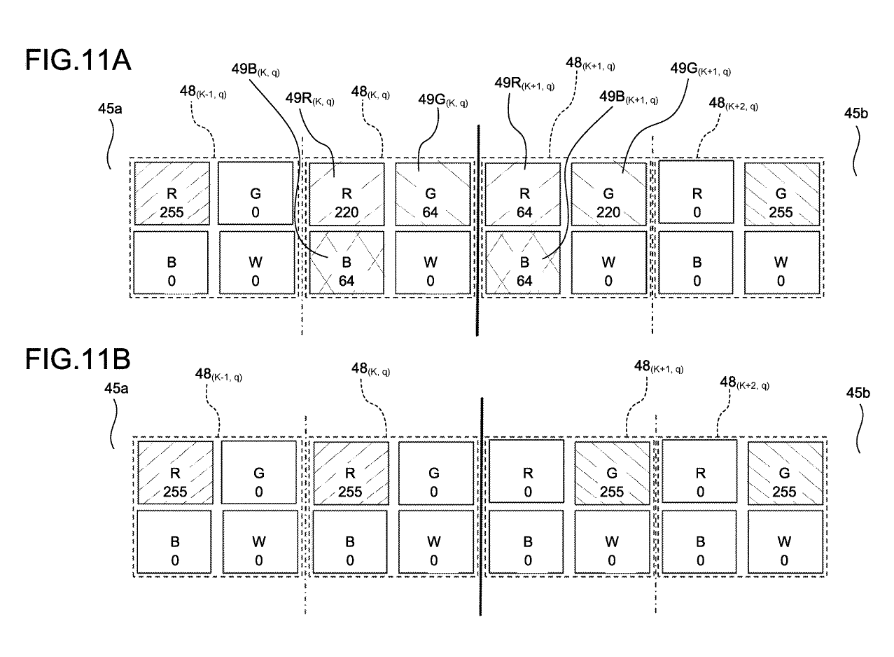

FIG. 11A is an enlarged view of the pixels on the q-th row near the boundary section 46 of FIG. 10. FIG. 11A illustrates, from the left side of the drawing sheet, the input signal values of the respective sub-pixels in the pixel 48_{(K-1, q)} not included in the boundary section 46 and the pixel 48_{(K, q)} in the boundary section 46 in the display region 45a, and the pixel 48_{(K+1, q)} in the boundary section 46 and the pixel 48_{(K+2, q)} not included in the boundary section 46 in the display region 45b.

For example, the number 255 described in the pixel 48_{(K-1, q)} in FIG. 11A indicates that an input signal value x₁_{_}_{(K-1, q)} of the first sub-pixel 49R_{(K}_{_{−}}_{1, q)} is 255. Similarly, an input signal value x₂_{_}_{(K-1, q)} of the second sub-pixel 49G_{(K-1, q)} is 0. In the first embodiment, the display gradation bit number is 8 (the values of display gradation are 256 gradations from 0 to 255). Therefore, the input signal value x takes an integer value from 0 to 255. To fully turn on the sub-pixel 49, an input signal value x “255” is input. Meanwhile, to turn off the sub-pixel 49, an input signal value x “0” is input.

The first sub-pixel 49R_{(K-1, q)} to which the input signal value x₁_{_}_{(K-1, q)} “255” is input is fully lighted. Meanwhile, the second sub-pixel 49G_{(K-1, q)} to which the input signal value x₂_{_}_{(K-1, q)} “0” is input is unlighted.

In FIG. 11A, the fourth sub-pixels 49W are unlighted. Therefore, the input signal value x₄_{_}_{(p, q)} to be input to an arbitrary fourth sub-pixel 49W_{(p, q)} is 0.

In the example illustrated in FIG. 11A, an input signal value x₁_{_}_{(K, q)} of the first sub-pixel 49R_{(K, q)} is 220, an input signal value x₂_{_}_{(K, q)} of the second sub-pixel 49G_{(K, q)} is 64, and an input signal value x₃_{_}_{(K, q)} of the third sub-pixel 49B_{(K, q)} is 64 in the boundary section 46 on the display region 45a side. The first sub-pixel 49R_{(K, q)} to which the input signal value x₁_{_{−1}} _{(K, q)} “220” is input is lighted in halftone luminance between an unlighted state and a fully lighted state. The second sub-pixel 49G_{(K, q)} to which the input signal value x₂_{_}_{(K, q)} “64” is input is lighted in the halftone luminance. The third sub-pixel 49B_{(K, q)} to which the input signal value x₃_{_}_{(K, q)} “64” is input is lighted in the halftone luminance.

In this way, by inputting the input signal value x that causes the sub-pixel to be lighted in halftone luminance to the first sub-pixel 49R_{(K, q)}, the second sub-pixel 49G_{(K, q)}, and the third sub-pixel 49B_{(K, q)}, which are the sub-pixels of the pixel 48_{(K, q)} in the boundary section 46, the first sub-pixel 49R_{(K, q)}, the second sub-pixel 49G_{(K, q)}, and the third sub-pixel 49B_{(K, q)} can be lighted in a halftone manner.

Further, the input signal value x₁_{_}_{(K, q)}, the input signal value x₂_{_}_{(K, q)}, and the input signal value x₃_{_}_{(K, q)} are preferably input in consideration of the sub-pixels originally supposed to be lighted and the sub-pixels originally supposed to be unlighted. That is, the first sub-pixel 49R_{(K, q)} is originally supposed to be fully lighted, in other words, an input signal value x₁_{_}_{(K, q)} “255” is input thereto. The second sub-pixel 49G_{(K, q)} is originally supposed to be unlighted, in other words, an input signal value x₂_{_}_{(K, q)} “0” is input thereto. The third sub-pixel 49B_{(K, q)} is originally supposed to be unlighted, in other words, an input signal value x₃_{_}_{(K, q)} “0” is input thereto.

In view of the foregoing, the input signal value x₁_{_}_{(K, q)} has preferably a larger signal value than the input signal value x₂_{_}_{(K, q)} and the input signal value x₃_{_}_{(K, (q)}, even if the sub-pixel is lighted in a halftone manner. As illustrated in FIG. 11A, the input signal value x₁_{_}_{(K, q)} “220” is larger than the input signal value x₂_{_}_{(K, q)} “64” and the input signal value x₃_{_}_{(K, q)} “64”, and thus the luminance of the first sub-pixel 49R_{(K, q)} is higher than the luminance of the second sub-pixel 49G_{(K, q)} and the third sub-pixel 49B_{(K, q)}. Accordingly, a luminance difference between the boundary section 46 and the display regions other than the boundary section 46 can be further reduced. The input signal values x of the sub-pixels 49 in different colors that are originally supposed to be unlighted may be the same or may be different from each other.

Similarly, in the example illustrated in FIG. 11A, an input signal value x₁_{_}_{(K+1, q)} of the first sub-pixel 49R_{(K+1, q)} is 64, an input signal value x₂_{_}_{(K+1, q)} of the second sub-pixel 49G_{(K+1, q)} is 220, and an input signal value x₃_{_}_{(K+1, q)} of the third sub-pixel 49B_{(K+1, q)} is 64 in the boundary section 46 on the display region 45b side. In this way, by inputting the input signal value x that causes the sub-pixel to be lighted in halftone luminance to the first sub-pixel 49R_{(K+1, q)}, the second sub-pixel 49G_{(K+1, q)}, and the third sub-pixel 49B_{(K+1, q)}, which are the sub-pixels of the pixel 48_{(K+1, q)} in the boundary section 46 on the display region 45b side, the first sub-pixel 49R_{(K+1, q)}, the second sub-pixel 49G_{(K+1, q)}, and the third sub-pixel 49B_{(K+1, q)} can be lighted in a halftone manner.

As described above, the sub-pixels 49 in the boundary section 46 are lighted in a halftone manner, and thus the luminance change in the boundary section can be reduced.

In FIG. 11A, the input signal values x that cause the sub-pixels to be lighted in halftone luminance are “220” and “64”. However, these values are mere examples. The input signal value x may be any value as long as the value causes the sub-pixel to be lighted in halftone luminance.

By setting the signal values such that the input signal value x of the sub-pixel that is originally supposed to be fully lighted becomes larger than the input signal value x of the sub-pixel that is originally supposed to be unlighted, the luminance difference between the boundary section 46 and the display regions other than the boundary section 46 can be further reduced.

In the pixel 48_{(K+2, q)} not included in the boundary section 46 on the display region 45b side, the second sub-pixel 49G_{(K+2, q)} to which an input signal value x₂_{_}_{(K+2, q)} “255” is input is fully lighted. Meanwhile, the first sub-pixel 49R_{(K+2, q)} to which an input signal value x₁_{_}_{(K+2, q)} “0” is input is unlighted. The third sub-pixel 49B_{(K+2, q)} to which an input signal value x₃_{_}_{(K+2, q)} “0” is input is unlighted.

As described with reference to FIG. 11A, in the boundary section 46, the input signal value to cause the sub-pixels that are originally supposed to be unlighted to display in a halftone manner is input thereto. Further, the input signal value to cause the sub-pixels that are originally supposed to be fully lighted to display in a halftone manner is also input thereto. Accordingly, the luminance change in the boundary section, and the luminance change between the boundary section and the display regions other than the boundary section are reduced, which prevents visual recognition of the black streak.

Further, the input signal value to be input to the sub-pixel that is originally supposed to be fully lighted is preferably made larger than the input signal value to be input to the sub-pixel that is originally supposed to be unlighted in the boundary section 46. By setting the input signal values in this way, the luminance change between the boundary section 46 and the display regions other than the boundary section 46 can be further reduced.

As described above, the visibility of a display image can be improved.

FIG. 11B is an enlarged view of the pixels on the q-th row near the boundary section 46 in FIG. 5. In FIG. 11B, the pixels included in the boundary section 46 are the pixel 48_{(K, q)} and the pixel 48_{(K+1, q)}.

In FIG. 11B, the input signal value x₁_{_}_{(K, q)} “255” is input to the first sub-pixel 49R_{(K, q)}, the input signal value x₂_{_}_{(K, q)} “0” is input to the second sub-pixel 49G_{(K, q)}, and the input signal value x₃_{_}_{(K, q)} “0” is input to the third sub-pixel 49B_{(K, q)} in the pixel 48 _{(K, q)} in the boundary section 46 on the display region 45a side. Therefore, the first sub-pixel 49R_{(K, q)} is fully lighted, and the second sub-pixel 49G_{(K, q)} and the third sub-pixel 49B_{(K, q)} are unlighted.

An input signal value x₂_{_}_{(K+1, q)} “255” is input to the second sub-pixel 49G_{(K+1, q)}, an input signal value x₁_{_}_{(K+1, q)} “0” is input to the first sub-pixel 49R_{(K+1, q)}, and an input signal value x₃_{_}_{(K+1, q)} “0” is input to the third sub-pixel 49B_{(K+1, q)} in the pixel 48_{(K+1, q)} in the boundary section 46 on the display region 45b side. The first sub-pixel 49R_{(K+1, q)} and the third sub-pixel 49B_{(K+1, q)} are unlighted, and the second sub-pixel 49G_{(K+1, q)} is fully lighted.

As illustrated in FIG. 11B, the second sub-pixel 49G_{(K, q)} and the first sub-pixel 49R_{(K+1, q)} are unlighted, which are arranged between the first sub-pixel 49R_{(K, q)} and the second sub-pixel 49G_{(K+1, q)} that are fully lighted. Neither the third sub-pixel 49B_{(K, q)} nor the third sub-pixel 49B_{(K+1, q)} is lighted. Such unlighted sub-pixels 49 are visually recognized as the black streak in the boundary section 46 where the different single colors are adjacent to each other.

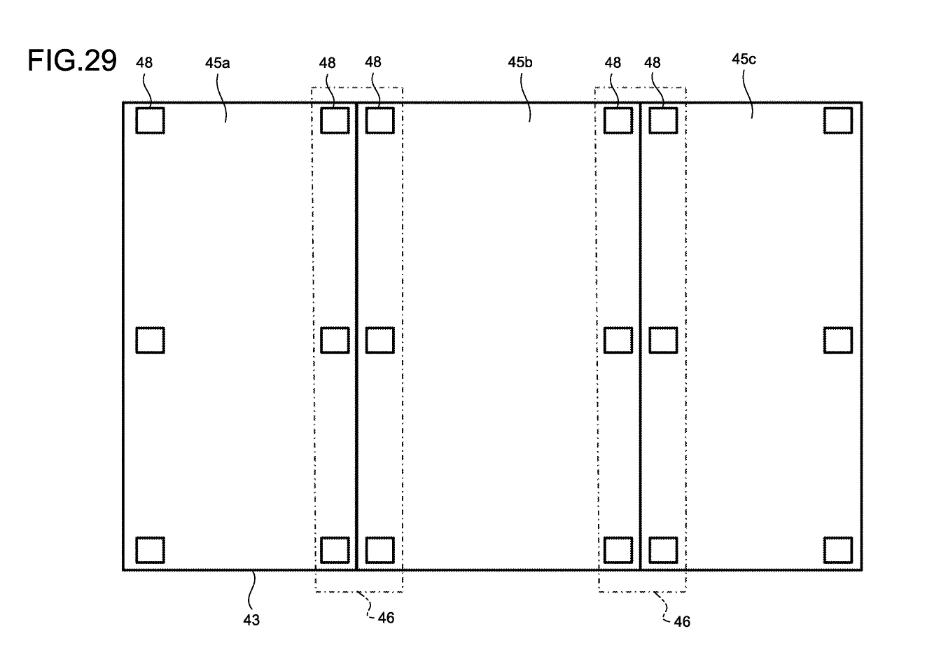

FIG. 29 illustrates an example in which three or more display regions 45 in single colors are adjacent to one another.

In FIG. 29, three display regions 45a, 45b, and 45c in single colors are arranged side by side, and pixel columns where the display region 45a and the display region 45b are adjacent to each other and pixel columns where the display region 45b and the display region 45c are adjacent to each other are the boundary sections 46.

Causing the pixels 48 included in the boundary sections 46 to be lighted in a halftone manner, as described above, prevents the boundary sections 46 from being visually recognized as streaks.

### First Modification of First Embodiment

In FIGS. 10 and 11A, an example to prevent occurrence of the black streak illustrated in FIGS. 4 to 6 has been described. Hereinafter, an example to prevent occurrence of the bright streak illustrated in FIGS. 7 to 9 will be described.

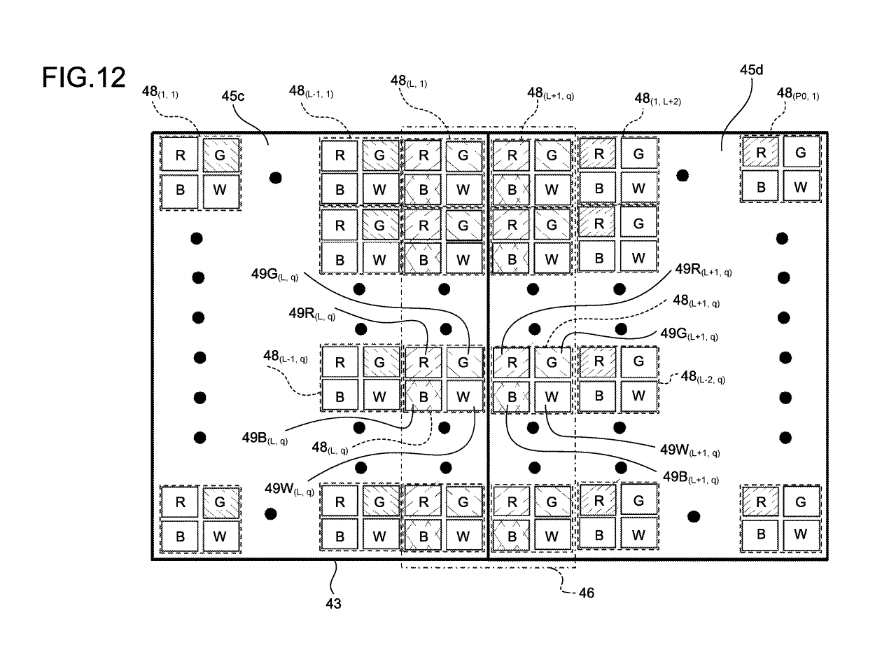

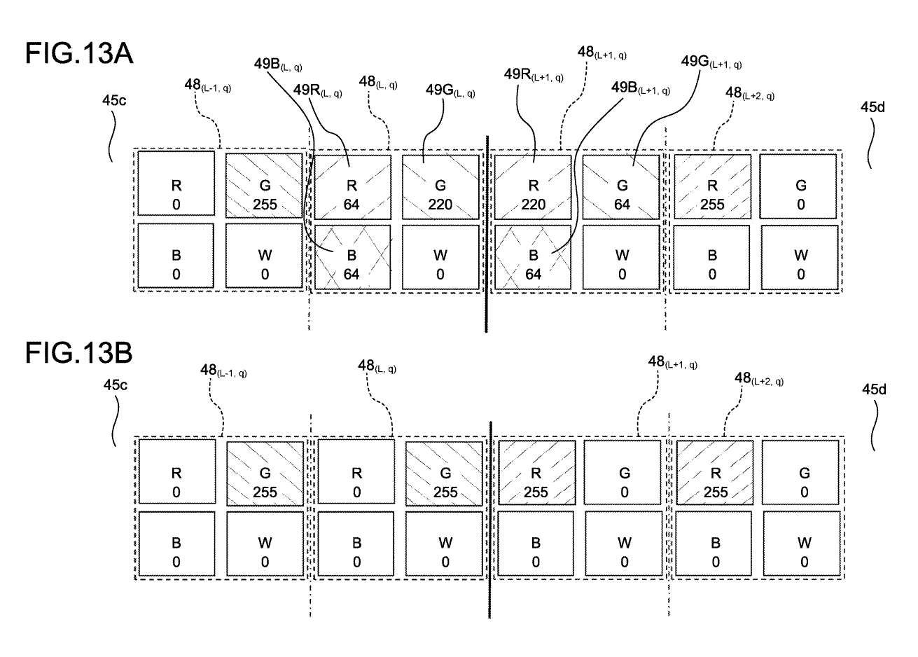

A first modification will be described using FIGS. 12 and 13.

FIG. 12 illustrates an example in which sub-pixels that are originally supposed to be unlighted, among sub-pixels in a boundary section 46, are lighted in a halftone manner in a display device illustrated in FIGS. 7 to 9. In

FIG. 12, a pixel 48_{(L, q)} on an L-th column on a display region 45c side and a pixel 48_{(L+1, q)} on an (L+1)-th column on a display region 45d side are adjacent to each other in the boundary section 46 of the display regions 45c and 45d (L is an integer of 2 or more, and (P₀−2) or less).

For example, on a q-th row of the boundary section 46, a first sub-pixel 49R_{(L, q)} and a third sub-pixel 49B_{(L, q)} of the pixel 48_{(L, q)} on the display region 45c side, which are unlighted in FIG. 8, are lighted in a halftone manner. A second sub-pixel 49G_{(L+1, q)} and a third sub-pixel 49B_{(L+1, q)} of the pixel 48_{(L+1, q)} on the display region 45d side, which are unlighted in FIG. 8, are lighted in a halftone manner.

Further, a second sub-pixel 49G_{(L, q)} of the pixel 48_{(L, q)} on the display region 45c side, which is fully lighted to display green in FIG. 8, is lighted in a halftone manner. Meanwhile, a first sub-pixel 49R_{(L+1, q)} of the pixel 48_{(L+1, q)} on the display region 45d side, which is fully lighted to display red in FIG. 8, is lighted in a halftone manner.

That is, in the pixel 48_{(L, q)} and the pixel 48_{(L+1, q)} adjacent to each other in the boundary section 46, the adjacent second sub-pixel 49G_{(L, q)} and first sub-pixel 49R_{(L+1, q)} that are originally supposed to be fully lighted are lighted in a halftone manner. Further, the first sub-pixel 49R_{(L, q)}, the third sub-pixel 49B_{(L, q)}, the second sub-pixel 49G _{(L+1, q)}, and the third sub-pixel 49B_{(L+1, q)} that are originally supposed to be unlighted are lighted in a halftone manner. As described above, the sub-pixels 49 in the boundary section 46 are lighted in a halftone manner, and thus luminance change in the boundary section is reduced.

Meanwhile, in the pixel 48 not included in the boundary section 46, for example, in the display region 45c, a pixel 48_{(L-1, q)} adjacent to the pixel 48_{(L, q)} is lighted similarly to FIG. 8. That is, a first sub-pixel 49R_{(L-1, q)} and a third sub-pixel 49B_{(L-1, q)} of the pixel 48_{(L-1, q)} are unlighted, and a second sub-pixel 49G_{(L-1, q)} is fully lighted. Similarly, in the display region 45d, a pixel 48_{(L+2, q)} adjacent to the pixel 48_{(L+1, q)} is lighted similarly to FIG. 8. That is, a first sub-pixel 49R_{(L+2, q)} is fully lighted, and a second sub-pixel 49G_{(L+2, q)} and a third sub-pixel 49B_{(L+2, q)} of the pixel 48_{(L+2, q)} are unlighted.

Luminance change is reduced between the pixel 48 in the boundary section 46, and the pixel 48 that is not included in the boundary section 46 and that is adjacent to the boundary section 46. For example, in the display region 45c, between the pixel 48_{(L, q)} in the boundary section 46 and the pixel 48_{(L-1, q)} adjacent to the pixel 48_{(L, q)}, the pixel 48_{(L, q)} is lighted in a halftone manner, and the pixel 48_{(L-1, q)} is lighted in a single color. To be more specific, the first sub-pixel 49R_{(L, q)} of the pixel 48_{(L, q)} is lighted in a halftone manner, and the second sub-pixel 49G_{(L-1, q)} of the pixel 48_{(L-1, q)} is fully lighted. The adjacent first sub-pixel 49R_{(L, q)} and second sub-pixel 49G_{(L-1, q)} are lighted in a halftone manner and fully lighted, respectively, and thus the luminance change is gradual.

In this way, the adjacent sub-pixels that are originally supposed to be fully lighted are lighted in a halftone manner, and the sub-pixels that are adjacent to the adjacent sub-pixels, and that are originally supposed to be unlighted are also lighted in a halftone manner. Therefore, the luminance change is reduced, which prevents a bright streak from being visually recognized. As described above, the visibility of a display image can be improved.

FIG. 13A is an enlarged view of the pixels on the q-th row near the boundary section 46 of FIG. 12. FIG. 13A illustrates, from the left side on the drawing sheet, input signal values of the respective sub-pixels in the pixel 48_{(L-1, q)} not included in the boundary section 46 and the pixel 48_{(L, q)} in the boundary section 46 in the display region 45c, and the pixel 48_{(L+1, q)} in the boundary section 46 and the pixel 48_{(L+2, q)} not included in the boundary section 46 in the display region 45d.

The first sub-pixel 49R_{(L-1, q)} to which an input signal value x₁_{_}_{(L-1, q)} “0” is input is unlighted. The third sub-pixel 49B_{(L-1, q)} to which an input signal value x₃_{_}_{(L-1, q)} “0” is input is unlighted. Meanwhile, the second sub-pixel 49G_{(L-1, q)} to which an input signal value x₂_{_}_{L-1, q)} “255” is input is fully lighted.

In FIG. 13A, fourth sub-pixels 49W are unlighted. Therefore, an input signal value x₄_{_}_{(p, q)} to be input to an arbitrary fourth sub-pixel 49W_{(p, q)} is 0.

In the example illustrated in FIG. 13A, an input signal value x₁_{_}_{(L, q)} of the first sub-pixel 49R_{(L, q)} is 64, an input signal value x₂_{_}_{(L, q)} of the second sub-pixel 49G_{(L, q)} is 220, and an input signal value x₃_{_}_{(L, q)} of the third sub-pixel 49B_{(L, q)} is 64 in the boundary section 46 on the display region 45c side. The first sub-pixel 49R_{(L, q)} to which the input signal value x₁_{_}_{(L, q)} “64” is input is lighted in halftone luminance. The second sub-pixel 49G_{(L, q)} to which the input signal value x₂_{_}_{(L, q)} “220” is input is lighted in halftone luminance. The third sub-pixel 49B_{(L, q)} to which the input signal value x₃_{_}_{(L, q)} “64” is input is lighted in halftone luminance.

In this way, by inputting the input signal value x that causes the sub-pixel to be lighted in halftone luminance to the first sub-pixel 49R_{(L, q)}, the second sub-pixel 49G_{(L, q)}, and the third sub-pixel 49B_{(L, q)}, which are the sub-pixels of the pixel 48_{(L, q)} in the boundary section 46, the first sub-pixel 49R_{(L, q)}, the second sub-pixel 49G_{(L, q)}, and the third sub-pixel 49B_{(L, q)} can be lighted in a halftone manner.

The input signal value x₁_{_}_{(L, q)}, the input signal value x₂_{_}_{(L, q)}, and the input signal value x₃_{_}_{(L, q}) are preferably input in consideration of the sub-pixels that are originally supposed to be lighted and the sub-pixels that are originally supposed to be unlighted. That is, the first sub-pixel 49R_{(L, q)} is originally supposed to be unlighted, in other words, an input signal value x₁_{_}_{(L, q)} “0” is input thereto. The second sub-pixel 49G_{(L, q)} is originally supposed to be fully lighted , in other words, an input signal value x₁_{_}_{(L, q)} “255” is input thereto. The third sub-pixel 49B_{(L, q)} is originally supposed to be unlighted, in other words, an input signal value x₃_{_}_{(L, q)} “0” is input thereto.

In view of the foregoing, the input signal value x₁_{_}_{(L, q)} and the input signal value x₃_{_}_{(L, q)} are preferably smaller than the input signal value x₂_{_}_{(L, q)} even if the sub-pixel is lighted in a halftone manner. As illustrated in FIG. 13A, the input signal value x₁_{_}_{(L, q)} and the input signal value x₃_{_}_{(L, q)} “64” are smaller than the input signal value x₂_{_}_{(L, q)} “220”. Therefore, the luminance of the first sub-pixel 49R_{(L, q)} and the third sub-pixel 49B_{(L, q)} is lower than the luminance of the second sub-pixel 49G_{(L, q)}. Accordingly, a luminance difference between the boundary section 46 and the display regions other than the boundary section 46 can be further reduced.

Similarly, in the example illustrated in FIG. 13A, an input signal value x₁_{_}_{(L+1, q)} of the first sub-pixel 49R_{(L+1, q)} is 220, an input signal value x₂_{_}_{(L+1, q)} of the second sub-pixel 49G_{(L+1, q)} is 64, and an input signal value x₃_{_}_{(L+1, q)} of the third sub-pixel 49B_{(L+1, q)} is 64 in the boundary section 46 on the display region 45d side. In this way, by inputting the input signal value x that causes the sub-pixel to be lighted in halftone luminance to the first sub-pixel 49R_{(L+1, q)}, the second sub-pixel 49G_{(L+1, q)}, and the third sub-pixel 49B_{(L+1, q)}, which are the sub-pixels of the pixel 48_{(L+1, q)} in the boundary section 46 on the display region 45d side, the first sub-pixel 49R_{(L+1, q)}, the second sub-pixel 49G_{(L+1, q)}, and the third sub-pixel 49B_{(L+1, q)} can be lighted in a halftone manner.

As described above, the sub-pixels 49 in the boundary section 46 are lighted in a halftone manner, and thus the luminance change in the boundary section can be reduced.

In FIG. 13A, the input signal values x that cause the sub-pixels to be lighted in halftone luminance are “220” and “64”. However, these values are mere examples. The input signal value x may be any value as long as the value causes the sub-pixel to be lighted in halftone luminance.

By setting the signal values such that the input signal value x of the sub-pixel that is originally supposed to be unlighted becomes smaller than the input signal value x of the sub-pixel that is originally supposed to be fully lighted, the luminance difference between the boundary section 46 and the display regions other than the boundary section 46 can be further reduced.

The first sub-pixel 49R_{(L+2, q)} to which an input signal value x₁_{_}_{(L+2, q)} “255” is input is fully lighted in the pixel 48_{(L+2, q)} not included in the boundary section 46 on the display region 45d side. Meanwhile, the second sub-pixel 49G_{(L+2, q)} to which an input signal value x₂_{_}_{(L+2, q)} “0” is input is unlighted. Further, the third sub-pixel 49B_{(L+2, q)} to which an input signal value x₃_{_}_{(L+2, q)} “0” is input is unlighted.

As described with reference to FIG. 13A, in the boundary section 46, the input signal value to cause the sub-pixels that are originally supposed to be fully lighted to display in a halftone manner is input thereto. Further, the input signal value to cause the sub-pixels that are originally supposed to be unlighted to display in a halftone manner is also input thereto. Accordingly, the luminance change in the boundary section, and the luminance change between the boundary section and the display regions other than the boundary section are reduced, which prevents the bright streak from being visually recognized.

Further, the input signal value to be input to the sub-pixel that is originally supposed to be unlighted is preferably made smaller than the input signal value to be input to the sub-pixel that is originally supposed to be fully lighted in the boundary section 46. By setting input signal values in this way, the luminance change between the boundary section 46 and the display regions other than the boundary section 46 can be further reduced.

As described above, the visibility of a display image can be improved.

FIG. 13B is an enlarged view of the pixels on the q-th row near the boundary section 46 in FIG. 8. In FIG. 13B, the pixels included in the boundary section 46 are the pixel 48_{(L, q)} and the pixel 48_{(L+1, q)}.

In FIG. 13B, in the pixel 48_{(L, q)} in the boundary section 46 on the display region 45c side, the input signal value x₁_{_}_{(L, q)} “0” is input to the first sub-pixel 49R_{(L, q)}, the input signal value x₂_{_}_{(L, q)} “255” is input to the second sub-pixel 49G_{(L, q)}, and the input signal value x₃_{_}_{(L, q)} “0” is input to the third sub-pixel 49B_{(L, q)}. Therefore, the first sub-pixel 49R_{(L, q)} and the third sub-pixel 49B_{(L, q)} are unlighted, and the second sub-pixel 49G_{(L, q)} is fully lighted.

In the pixel 48_{(L+1, q)} in the boundary section 46 on the display region 45d side, the input signal value x_{q}_{_}_{(L+1, q)} “255” is input to the first sub-pixel 49R_{(L+1, q)}, the input signal value x₂_{_}_{(L+1, q)} “0” is input to the second sub-pixel 49G_{(L+1, q)}, and the input signal value x₃_{_}_{(L+1, q)} “0” is input to the third sub-pixel 49B_{(L+1, q)}. The first sub-pixel 49R_{(L+1, q)} is fully lighted, and the second sub-pixel 49G_{(L+1, q)} and the third sub-pixel 49B_{(L+1, q)} are unlighted.

As illustrated in FIG. 13B, the adjacent second sub-pixel 49G_{(L, q)} and first sub-pixel 49R_{(L+1, q)} are fully lighted. Further, the first sub-pixel 49R_{(L, q)} of the pixel 48_{(L, q)}, and the second sub-pixel 49G_{(L+1, q)} of the pixel 48_{(L+1, q)} are unlighted. Neither the third sub-pixel 49B_{(L, q)} nor the third sub-pixel 49B_{(L+}^{1, q)} is lighted. In this way, in the boundary section 46 where different single colors are displayed, the single colors are mixed with each other, and are visually recognized as a bright streak.

The present modification is applicable to a configuration of having three or more display regions, as described in the first embodiment.

### Second Modification of First Embodiment

In the first embodiment and the first modification thereof, an example of displaying the primary colors of the single colors adjacent to each other has been described. In a second modification of the first embodiment, an example of displaying complementary colors of primary colors, for example, an example of displaying any two of cyan (C), magenta (M), yellow (Y) adjacent to each other will be described.

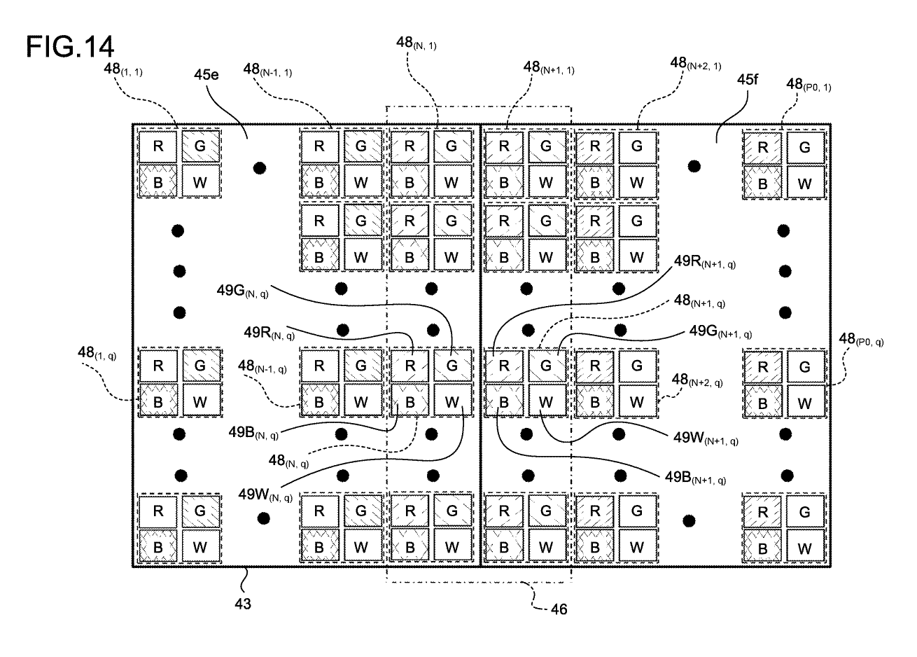

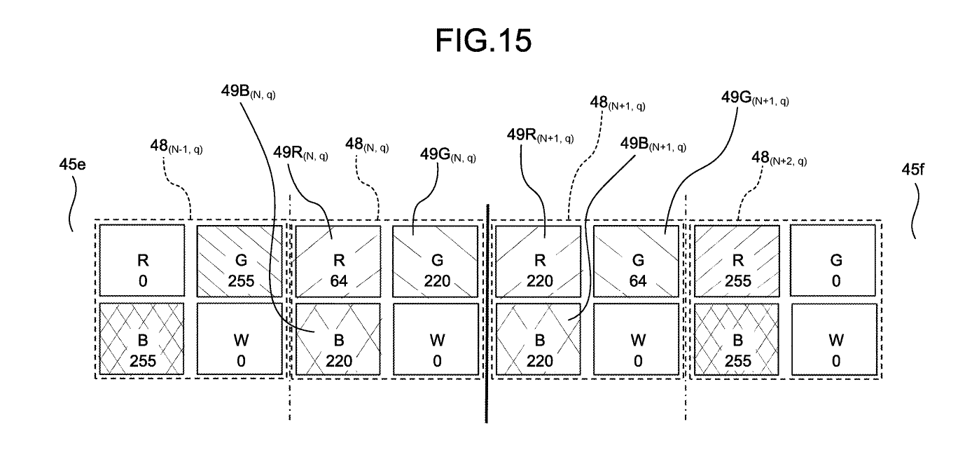

The second modification will be described with reference to FIGS. 14 and 15.

FIG. 14 illustrates an example of displaying cyan and magenta adjacent to each other as single colors. In FIG. 14, in a boundary section 46 of a display region 45e in which cyan is displayed and a display region 45f where magenta is displayed, a pixel 48_{(N, q)} on an N-th column on the display region 45e side and a pixel 48_{(N+1, q)} on an (N+1)-th column on the display region 45f side are adjacent to each other (N is an integer of two or more, and (P₀−2) or less).

To display cyan, a second sub-pixel 49G and a third sub-pixel 49B may be lighted. To display magenta, a first sub-pixel 49R and a third sub-pixel 49B may be lighted.

Therefore, regarding the pixels 48 not included in the boundary section 46, the second sub-pixels 49G and the third sub-pixels 49B are fully lighted, and the first sub-pixel 49R and fourth sub-pixel 49W are unlighted in a pixel 48_{(1, q)} to a pixel 48_{(N-1, q)} in the display region 45e. Similarly, regarding the pixels 48 not included in the boundary section 46, the first sub-pixels 49R and the third sub-pixels 49B are fully lighted, and the second sub-pixels 49G and the fourth sub-pixels 49W are unlighted in a pixel 48_{(N+2, q)} to a pixel 48_{(P0, q)} in the display region 45f.

In the boundary section 46, the pixel 48_{(N, q)} on the display region 45e side and the pixel 48_{(N+1, q)} on the display region 45f side are lighted in a halftone manner. More specific example will be described below.

For example, on a q-th row in the boundary section 46, a first sub-pixel 49R_{(N, q)} of the pixel 48_{(N, q)} on the display region 45e side, which is originally supposed to be unlighted, is lighted in a halftone manner.

Further, a second sub-pixel 49G_{(N, q)} and a third sub-pixel 49B_{(N, q)} of the pixel 48_{(N, q)} on the display region 45e side, which are originally supposed to be fully lighted, are lighted in a halftone manner.

A second sub-pixel 49G_{(N+1, q)} of the pixel 48_{(N+1, q)} on the display region 45f side, which is originally supposed to be unlighted, is lighted in a halftone manner.

Further, a first sub-pixel 49R_{(N+1, q)} and a third sub-pixel 49B_{(N+1, q)} of the pixel 48_{(N+1, q)} on the display region 45f side, which are originally supposed to be fully lighted, are lighted in a halftone manner.

In FIG. 14, none of the fourth sub-pixels 49W is lighted.

As described above, the sub-pixels 49 in the boundary section 46 are lighted in a halftone manner, and thus luminance change in the boundary section is reduced.

The luminance change is reduced between the pixel 48 in the boundary section 46, and the pixel 48 that is not included in the boundary section 46 and that is adjacent to the boundary section 46. For example, in the display region 45e, the pixel 48_{(N, q)} is lighted in a halftone manner and the pixel 48_{(N-1, q)} is fully lighted between the pixel 48_{(N, q)} in the boundary section 46 and the pixel 48_{(N-1, q)} adjacent to the pixel 48_{(N, q)}. Accordingly, the luminance change in the boundary section 46 and the regions other than the boundary section 46 is reduced.

Accordingly, the luminance change in the boundary section 46, and the luminance change between the boundary section and the display regions other than the boundary section are reduced, which prevents a streak in the boundary section from being visually recognized.

In this way, the sub-pixels that are originally supposed to be unlighted are lighted in a halftone manner, and the sub-pixels that are originally supposed to be fully lighted are also lighted in a halftone manner. Therefore, the luminance change is reduced, which prevents the streak from being visually recognized. As described above, the visibility of a display image can be improved.

FIG. 15 is an enlarged view of the pixels on the q-th row near the boundary section 46 of FIG. 14. FIG. 15 illustrates, from the left side on the drawing sheet, input signal values of the respective sub-pixels in the pixel 48_{(N-1, q)} not included in the boundary section 46 and the pixel 48_{(N, q)} in the boundary section 46 in the display region 45e, and the pixel 48_{(N+1, q)} in the boundary section 46 and the pixel 48_{(N+2, q)} not included in the boundary section 46 in the display region 45f.

A second sub-pixel 49G_{(N-1, q)} to which an input signal value x₂_{_}_{(N-q)} “255” is input is fully lighted. A third sub-pixel 49B_{(N-1, q)} to which an input signal value x₃_{_}_{(N-1, q)} “255” is input is fully lighted. Meanwhile, a first sub-pixel 49R_{(N-1, q)} to which an input signal value x₁_{_}_{(N-1, q)} “0” is input is unlighted.

In FIG. 15, the fourth sub-pixels 49W are unlighted. Therefore, an input signal value x₄_{_}_{(p, q)} to be input to an arbitrary fourth sub-pixel 49W_{(p, q)} is 0.

In the example illustrated in FIG. 15, an input signal value x₁_{_}_{(N, q)} of the first sub-pixel 49R_{(N, q)} is 64, an input signal value x₂_{_}_{(N, q)} of the second sub-pixel 49G_{(N, q)} is 220, and an input signal value x₃_{_}_{(N, q)} of the third sub-pixel 49B_{(N, q)} is 220 in the boundary section 46 on the display region 45e side. The first sub-pixel 49R_{(N, q)} to which the input signal value x₁_{_}_{(N, q)} “64” is input is lighted in halftone luminance. The second sub-pixel 49G_{(N, q)} to which the input signal value x₂_{_}_{(N, q)} “220” is input is lighted in halftone luminance. The third sub-pixel 49B_{(N, q)} to which the input signal value x₃_{_}_{(N, q)} “220” is input is lighted in halftone luminance.

In this way, by inputting the input signal value x that causes the sub-pixel to be lighted in halftone luminance to the first sub-pixel 49R_{(N, q)}, the second sub-pixel 49G_{(N, q)}, and the third sub-pixel 49B_{(N, q)}, which are the sub-pixels of the pixel 48_{(N, q)} in the boundary section 46, the first sub-pixel 49R_{(N, q)}, the second sub-pixel 49G_{(N, q)}, and the third sub-pixel 49B_{(N, q)} are lighted in a halftone manner.

Further, the input signal value x₁_{_}_{(N, q)}, the input signal value x₂_{_}_{N, q)}, and the input signal value x₃_{_}_{(N, q)} are preferably input in consideration of the sub-pixels that are originally supposed to be lighted and the sub-pixels that are originally supposed to be unlighted. That is, the first sub-pixel 49R_{(N, q)} is originally supposed to be unlighted, in other words, an input signal value x₁_{_}_{(N, q)} “0” is input thereto. The second sub-pixel 49G_{(N, q)} is originally supposed to be fully lighted, in other words, an input signal value x₂_{_}_{(N, q)} “255” is input thereto. The third sub-pixel 49B_{(N, q)} is originally supposed to be fully lighted, in other words, an input signal value x₃_{_}_{(N, q)} “255” is input thereto. In view of the foregoing, the input signal value x for causing the sub-pixel to be lighted in a halftone manner is preferably input in consideration of the input signal value x that is originally supposed to be input.

Similarly, in the example illustrated in FIG. 15, an input signal value x₁_{_}_{(N+1, q)} of the first sub-pixel 49R_{(N+1, q)} is 220, an input signal value x₂_{_}_{(N+1, q)} of the second sub-pixel 49G_{(N+1, q)} is 64, and an input signal value x₃_{_}_{(N+1, q)} of the third sub-pixel 49B_{(N+1, q)} is 220 in the boundary section 46 on the display region 45f side. In this way, by inputting the input signal value x that causes the sub-pixel to be lighted in halftone luminance to the first sub-pixel 49R_{(N+1, q)}, the second sub-pixel 49G_{(N+1, q)}, and the third sub-pixel 49B_{(N+1, q)}, which are the sub-pixels of the pixel 48_{(N+1, q)} in the boundary section 46 on the display region 45f side, the first sub-pixel 49R_{(N+1, q)}, the second sub-pixel 49G_{(N+1, q)}, and the third sub-pixel 49B_{(N+1, q)} can be lighted in a halftone manner.

As described above, the sub-pixels 49 in the boundary section 46 are lighted in a halftone manner, and thus the luminance change in the boundary section can be reduced.

In FIG. 15, the input signal values x that cause the sub-pixels to be lighted in halftone luminance are “220” and “64”. However, these values are mere examples. The input signal value x may be any value as long as the value causes the sub-pixel to be lighted in halftone luminance.

As described in the first embodiment and its first modification, by setting the signal values such that the input signal value x of the sub-pixel that is originally supposed to be fully lighted becomes larger than the input signal value x of the sub-pixel that is originally supposed to be unlighted, a luminance difference between the boundary section 46 and the display regions other than the boundary section 46 can be further reduced.

In the pixel 48_{(N+2, q)} not included in the boundary section 46 on the display region 45f side, a first sub-pixel 49R_{(N+2, q)} to which an input signal value x₁_{_}_{(N+2, q)} “255” is input is fully lighted. A third sub-pixel 49B_{(N+2, q)} to which an input signal value x₃_{_}_{(N+2, q)} “255” is input is fully lighted. Meanwhile, a second sub-pixel 49G_{(N+2, q)} to which an input signal value x₂_{_}_{(N+2, q)} “0” is input is unlighted.

As described using FIG. 15, in the boundary section 46, the input signal value to cause the sub-pixels that are originally supposed to be unlighted to display in a halftone manner is input thereto. Further, the input signal value to cause the sub-pixels that are originally supposed to be fully lighted to display in a halftone manner is also input thereto. Accordingly, the luminance change in the boundary section, and the luminance change between the boundary section and the display regions other than the boundary section are reduced, which prevents the streak from being visually recognized.

As described above, the visibility of a display image can be improved.

In the second modification, as an example of displaying the complementary colors of primary colors, an example of displaying cyan in the display region 45e and magenta in the display region 45f has been described. However, even in a case of displaying the complementary colors of other primary colors, the visual recognition of the streak can be eliminated, and the visibility of a display image can be improved.

Especially, as a combination of colors in the display region 45e (left side) and the display region 45f (right side), a combination of yellow (Y) and cyan (C), that of yellow (Y) and magenta (M), that of cyan (C) and yellow (Y), and that of cyan (C) and magenta (M) provide significant effects.

The present modification is applicable to a configuration of having three or more display regions, as described in the first embodiment.

### Third Modification of First Embodiment

In a third modification of the first embodiment, an example of displaying a primary color and its complementary color adjacent to each other, for example, an example of displaying red (R) and cyan (C), green (G) and magenta (M), blue (B) and yellow (Y), respectively adjacent to each other, will be described.

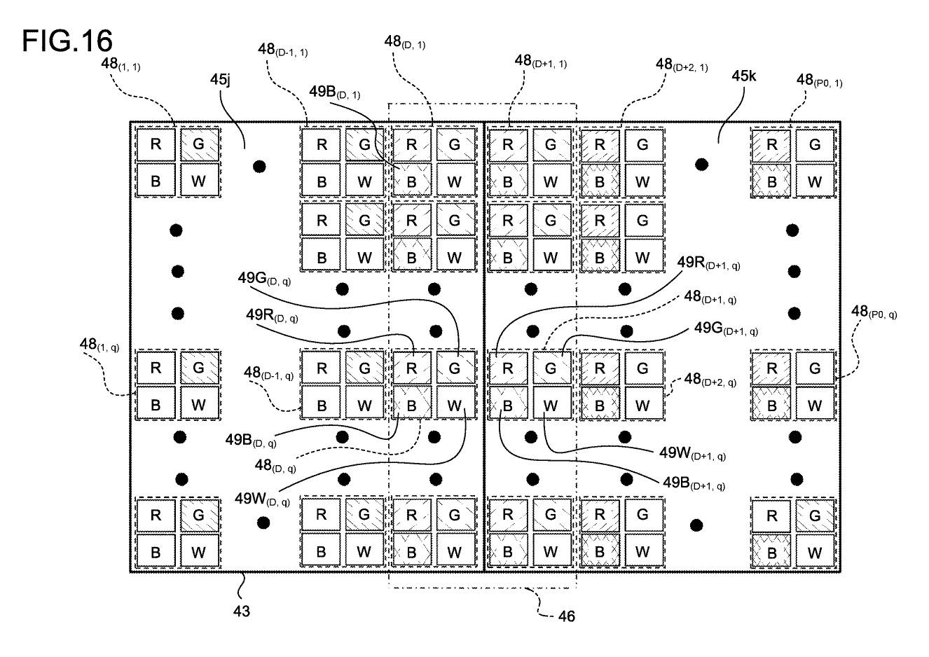

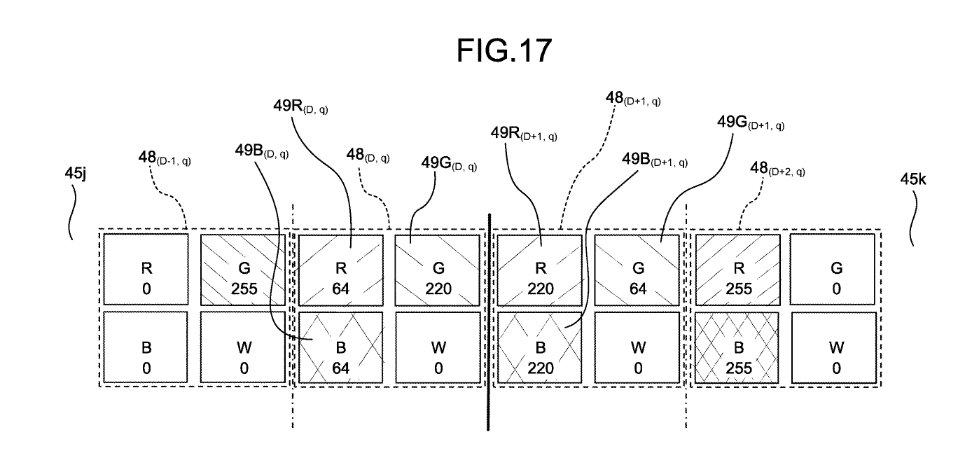

The third modification will be described with reference to FIGS. 16 and 17.

FIG. 16 illustrates an example of displaying green and magenta adjacent to each other as single colors. In FIG. 16, assume that in a boundary section 46 of a display region 45j where green is displayed and a display region 45k where magenta is displayed, a pixel 48_{(D, q)} on a D-th column on the display region 45j side and a pixel 48_{(D+1, q)} on a (D+1)-th column on the display region 45k side are adjacent to each other (D is an integer of 2 or more, and (P₀−2) or less).

To display green, a second sub-pixel 49G may be lighted. To display magenta, a first sub-pixel 49R and a third sub-pixel 49B may be lighted.

Therefore, regarding the pixels 48 not included in the boundary section 46, the second sub-pixels 49G are fully lighted, and the first sub-pixels 49R, the third sub-pixels 49B, and fourth sub-pixels 49W are unlighted in a pixel 48_{(1, q)} to a pixel 48_{(D-1, q)} in the display region 45j. Similarly, regarding the pixels 48 not included in the boundary section 46, the first sub-pixels 49R and the third sub-pixels 49B are fully lighted, and the second sub-pixels 49G and the fourth sub-pixels 49W are unlighted in a pixel 48_{(D+2, q)} to a pixel 48 _{(P0, q)} in the display region 45k.

In the boundary section 46, the pixel 48_{(D, q)} on the display region 45j side and the pixel 48_{(D+1, q)} on the display region 45k side are lighted in a halftone manner. More specific example will be described below.

For example, on a q-th row in the boundary section 46, a first sub-pixel 49R_{(D, q)} and a third sub-pixel 49B_{(D, q)} of the pixel 48_{(D, q)} on the display region 45j side, which are originally supposed to be unlighted, are lighted in a halftone manner.

Further, a second sub-pixel 49G_{(D, q)} of the pixel 48_{(D, q)} on the display region 45j side, which is originally supposed to be fully lighted, is lighted in a halftone manner.

A second sub-pixel 49G_{(D+1, q)} of the pixel 48_{(D+1, q)} on the display region 45k side, which is originally supposed to be unlighted, is lighted in a halftone manner.

Further, a first sub-pixel 49R_{(D+1, q)} and a third sub-pixel 49B_{(D+1, q)} of the pixel 48_{(D+1, q)} on the display region 45k side, which are originally supposed to be fully lighted, are lighted in a halftone manner.

In FIG. 16, the fourth sub-pixels 49W are unlighted.

As described above, the sub-pixels 49 in the boundary section 46 are lighted in a halftone manner, and thus luminance change in the boundary section is reduced.

The luminance change is reduced between the pixel 48 in the boundary section 46, and the pixel 48 that is not included in the boundary section 46 and that is adjacent to the boundary section 46. For example, in the display region 45j, the pixel 48_{(D, q)} is lighted in a halftone manner, and the pixel 48_{(D-1, q)} is lighted in the single color between the pixel 48_{(D, q)} in the boundary section 46 and the pixel 48_{(D-1, q)} adjacent to the pixel 48_{(D, q)}. Accordingly, the luminance change in the boundary section 46 and the regions other than the boundary section 46 is reduced.

Accordingly, the luminance change in the boundary section 46, and the luminance change between the boundary section and the display regions other than the boundary section are reduced, which prevents a streak in the boundary section from being visually recognized.

In this way, the sub-pixels that are originally supposed to be unlighted are lighted in a halftone manner, and the sub-pixels that are originally supposed to be fully lighted are also lighted in a halftone manner. Therefore, the luminance change is reduced, which prevents the streak from being visually recognized. As described above, the visibility of a display image can be improved.

FIG. 17 is an enlarged view of the pixels on the q-th row near the boundary section 46 of FIG. 16. FIG. 17 illustrates, from the left side on the drawing sheet, input signal values of the respective sub-pixels in the pixel 48_{(D-1, q)} not included in the boundary section 46 and the pixel 48_{(D, q)} in the boundary section 46 in the display region 45j, and the pixel 48_{(D+1, q)} in the boundary section 46 and the pixel 48_{(D+2, q)} not included in the boundary section 46 in the display region 45k.

A first sub-pixel 49R_{(D-1, q)} to which an input signal value x₁_{_}_{(D-1, q)} “0” is input is unlighted. Meanwhile, a second sub-pixel 49G_{(D-1, q)} to which an input signal value x₂_{_}_{(D-1, q)} “255” is input is fully lighted. A third sub-pixel 49B_{(D-1, q)} to which an input signal value x₃_{_}_{(D-1, q)} “0” is input is unlighted.

In FIG. 17, the fourth sub-pixels 49W are unlighted. Therefore, an input signal value x₄_{_}_{(p, q)} to be input to an arbitrary fourth sub-pixel 49W_{(p, q)} is 0.

In the example illustrated in FIG. 17, an input signal value x₁_{_}_{(D, q)} of the first sub-pixel 49R_{(D, q)} is 64, an input signal value x₂_{_}_{(D, q)} of the second sub-pixel 49G_{(D, q)} is 220, and an input signal value x₃_{_}_{(D, q)} of the third sub-pixel 49B_{(D, q)} is 64 in the boundary section 46 on the display region 45j side. The first sub-pixel 49R_{(D, q)} to which the input signal value x₁_{_}_{(D, q)} “64” is input is lighted in halftone luminance. The second sub-pixel 49G_{(D, q)} to which the input signal value x₂_{_}_{(D, q)} “220” is input is lighted in halftone luminance. The third sub-pixel 49B_{(D, q)} to which the input signal value x₃_{_}_{(D, q)} “64” is input is lighted in halftone luminance.

In this way, by inputting the input signal value x that causes the sub-pixel to be lighted in halftone luminance to the first sub-pixel 49R_{(D, q)}, the second sub-pixel 49G_{(D, q)}, and the third sub-pixel 49B_{(D, q)}, which are the sub-pixels of the pixel 48_{(D, q)} in the boundary section 46, the first sub-pixel 49R_{(D, q)}, the second sub-pixel 49G_{(D, q)}, and the third sub-pixel 49B_{(D, q)} are lighted in a halftone manner.

Further, the input signal value x₁_{_}_{(D, q)}, the input signal value x₂_{_}_{(D, q)}, and the input signal value x₃_{_}_{(D, q)} are preferably input in consideration of the sub-pixels that are originally supposed to be lighted and the sub-pixels that are originally supposed to be unlighted. That is, the first sub-pixel 49R_{(D, q)} is originally supposed to be unlighted, in other words, an input signal value x₁_{_}_{(D, q)} “0” is input thereto. The second sub-pixel 49G_{(D, q)} is originally supposed to be fully lighted, in other words, an input signal value x₂_{_}_{(D, q)} “255” is input thereto. The third sub-pixel 49B_{(D, q)} is originally supposed to be unlighted, in other words, an input signal value x₃_{_}_{(D, q)} “0” is input thereto. In view of the foregoing, the input signal value x for causing the sub-pixel to be lighted in a halftone manner is preferably input in consideration of the input signal value x that is originally supposed to be input.

Similarly, in the example illustrated in FIG. 17, an input signal value x₁_{_}_{(D+1, q)} of the first sub-pixel 49R_{(D+1, q)} is 220, an input signal value x₂_{_}_{(D+1, q)} of the second sub-pixel 49G_{(D+1, q)} is 64, and an input signal value x₃_{_}_{(D+1, q)} of the third sub-pixel 49B_{(D+1, q)} is 220 in the boundary section 46 on the display region 45k side. In this way, by inputting the input signal value x that causes the sub-pixel to be lighted in halftone luminance to the first sub-pixel 49R_{(D+1, q)}, the second sub-pixel 49G_{(D+1, q)}, and the third sub-pixel 49B _{(D+1, q)}, which are the sub-pixels of the pixel 48_{(D+1, q)} in the boundary section 46 on the display region 45k side, the first sub-pixel 49R _{(D+1, q)}, the second sub-pixel 49G_{(D+1, q)}, and the third sub-pixel 49B_{(D+1, q)} can be lighted in a halftone manner.

As described above, the sub-pixels 49 in the boundary section 46 are lighted in a halftone manner, and thus the luminance change in the boundary section can be reduced.

In FIG. 17, the input signal values x that cause the sub-pixels to be lighted in halftone luminance are “220” and “64”. However, these values are mere examples. The input signal value x may be any value as long as the value causes the sub-pixel to be lighted in halftone luminance.

As described in the first embodiment and the first and second modifications thereof, by setting the signal values such that the input signal value x of the sub-pixel that is originally supposed to be fully lighted becomes larger than the input signal value x of the sub-pixel that is originally supposed to be unlighted, a luminance difference between the boundary section 46 and the display regions other than the boundary section 46 can be further reduced.

In the pixel 48_{(D+2, q)} not included in the boundary section 46 on the display region 45k side, a first sub-pixel 49R_{(D+2, q)} to which an input signal value x₁_{_}_{(D+2, q)} “255” is input is fully lighted. A third sub-pixel 49B_{(D+2, q)} to which an input signal value x₃_{_}_{(D+2, q)} “255” is input is fully lighted. Meanwhile, a second sub-pixel 49G_{(D+2, q)} to which an input signal value x₂_{_}_{(D+2, q)} “0” is input is unlighted.

As described with reference to FIG. 17, in the boundary section 46, the input signal value to cause the sub-pixels that are originally supposed to be unlighted to display in a halftone manner is input thereto. Further, the input signal value to cause the sub-pixels that are originally supposed to be fully lighted to display in a halftone manner is also input thereto. Accordingly, the luminance change in the boundary section, and the luminance change between the boundary section and the display regions other than the boundary section are reduced, which prevents the streak from being visually recognized.

As described above, the visibility of a display image can be improved.

In the third modification, an example of displaying green in the display region 45j and magenta in the display region 45k has been described. However, similar effect can be obtained even if the colors to be displayed are reversed. That is, even if magenta is displayed in the display region 45j and green is displayed in the display region 45k, the visual recognition of the streak can be prevented, and the visibility of a display image can be improved. Further, as described above, the same can be applied to a case where another primary color and its complementary color are displayed.

Especially, as a combination of colors in the display region 45j (left side) and the display region 45k (right side), a combination of cyan (C) and red (R), that of green (G) and magenta (M), that of magenta (M) and green (G), and that of yellow (Y) and blue (B) provide significant effects.

The present modification is applicable to a configuration having three or more display regions, as described in the first embodiment.

### Fourth Modification of First Embodiment

In the first embodiment and the first to third modifications thereof, an example of laterally arranging the display regions in the single colors and complementary colors in plan view has been described. In a fourth modification of the first embodiment, an example of longitudinally arranging display regions in plan view will be described.

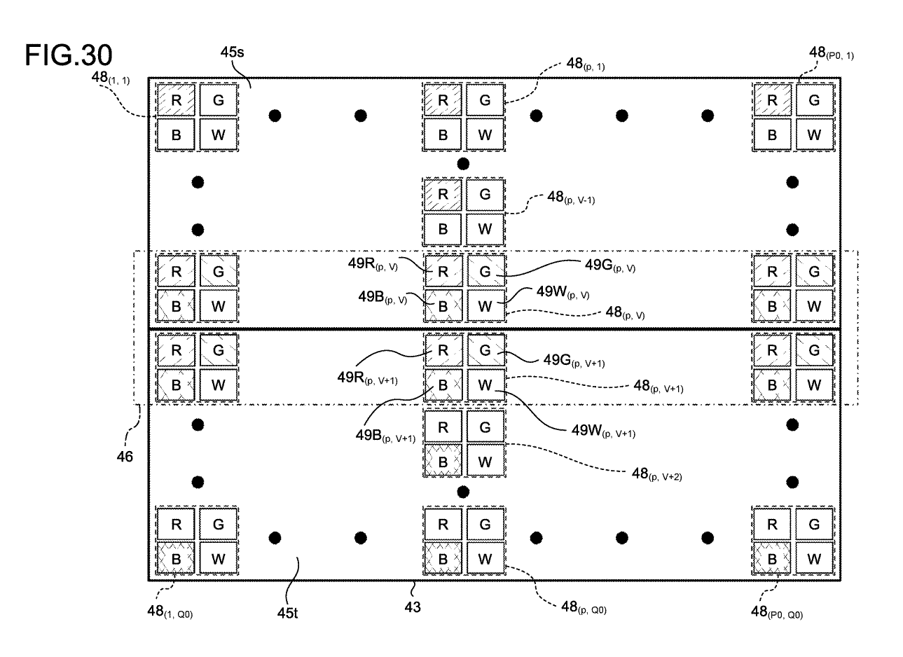

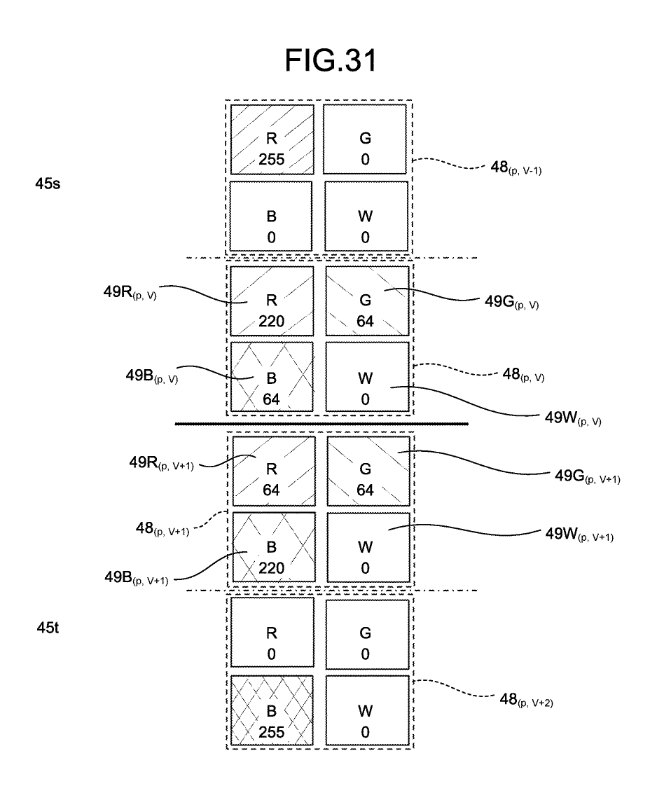

The fourth modification will be described with reference to FIGS. 30 and 31.

FIG. 30 illustrates an example of displaying red and blue longitudinally adjacent to each other as single colors. In FIG. 30, assume that in a boundary section 46 of a display region 45s where red is displayed and a display region 45t where blue is displayed, a pixel 48_{(p, v)} on a V-th row on the display region 45s side and a pixel 48_{(p, v+1)} on a (V+1)-th row on the display region 45t side are adjacent to each other (V is an integer of (Q₀−1) or less).

To display red, a first sub-pixel 49R may be lighted. To display blue, a third sub-pixel 49B may be lighted.

Therefore, regarding the pixels 48 not included in the boundary section 46, the first sub-pixels 49R are fully lighted, and the second sub-pixels 49G, the third sub-pixels 49B, and the fourth sub-pixels 49W are unlighted in a pixel 48_{(p, 1)} to a pixel 48_{(p, V-1)} in the display region 45s. Similarly, regarding the pixels 48 not included in the boundary section 46, the third sub-pixels 49B are fully lighted, and the first sub-pixels 49R, the second sub-pixels 49G, and the fourth sub-pixels 49W are unlighted in a pixel 48_{(p, V+2)} to a pixel 48_{(p, Q0)} in the display region 45t.

In the boundary section 46, the pixel 48_{(p, V)} on the display region 45s side and the pixel 48_{(p, V+1)} on the display region 45t side are lighted in a halftone manner. More specific example will be described below.

For example, on a p-th column in the boundary section 46, a second sub-pixel 49G_{(p, V)} and a third sub-pixel 49B_{(p, V)} of the pixel 48_{(p, V)} on the display region 45s side, which are originally supposed to be unlighted, are lighted in a halftone manner.

Further, a first sub-pixel 49R_{(p, V)} of the pixel 48_{(p, V)} on the display region 45s side, which is originally supposed to be fully lighted, is lighted in a halftone manner.

A first sub-pixel 49R_{(p, V+1)} and a second sub-pixel 49G_{(p, V+1)} of the pixel 48_{(p, V+1)} on the display region 45t side, which are originally supposed to be unlighted, are lighted in a halftone manner.

Further, a third sub-pixel 49B_{(p, V+1)} of the pixel 48_{(p, V+1)} on the display region 45t side, which is originally supposed to be fully lighted, is lighted in a halftone manner.

In FIG. 30, the fourth sub-pixels 49W are unlighted. As described above, the sub-pixels 49 in the boundary section 46 are lighted in a halftone manner, and thus luminance change in the boundary section is reduced.

The luminance change is reduced between the pixel 48 in the boundary section 46, and the pixel 48 that is not included in the boundary section 46 and that is adjacent to the boundary section 46. For example, in the display region 45s, the pixel 48_{(p, V)} is lighted in a halftone manner, and the pixel 48_{(p, V-1)} is lighted in the single color between the pixel 48_{(p, V)} in the boundary section 46, and the pixel 48_{(p, V-1)} adjacent to the pixel 48_{(p, V)}. Accordingly, the luminance change in the boundary section 46 and the regions other than the boundary section 46 is reduced. Similarly, in the display region 45t, a third sub-pixel 49B_{(p, V+2)} is fully lighted, and a first sub-pixel 49R_{(p, V+2)} and a second sub-pixel 49G_{(p, V+2)} are unlighted in the pixel 48_{(p, V+2)} adjacent to the pixel 48_{(p, V+1)}.

Accordingly, the luminance change in the boundary section 46, and the luminance change between the boundary section and the display regions other than the boundary section are reduced, which prevents a streak in the boundary section from being visually recognized.

In this way, the sub-pixels that are originally supposed to be unlighted are lighted in a halftone manner, and the sub-pixels that are originally supposed to be fully lighted are also lighted in a halftone manner. Therefore, the luminance change is reduced, which prevents the streak from being visually recognized. As described above, the visibility of a display image can be improved.

FIG. 31 is an enlarged view of the pixels on the p-th column near the boundary section 46 of FIG. 30. FIG. 31 illustrates, from the upper side on the drawing sheet, input signal values of the respective sub-pixels in the pixel 48_{(p, V-1)} not included in the boundary section 46 and the pixel 48_{(p, V)} in the boundary section 46 in the display region 45s, and the pixel 48_{(p, V+1)} in the boundary section 46 and the pixel 48_{(p, V+2)} not included in the boundary section 46 in the display region 45t.

A first sub-pixel 49R_{(p, V-1)} to which an input signal value x₁_{_}_{(p, V-1)} “255” is input is fully lighted. Meanwhile, a second sub-pixel 49G_{(p, V-1)} to which an input signal value x₂_{_}_{(p, V-1)} “0” is input is unlighted. A third sub-pixel 49B_{(p, V-1}) to which an input signal value x₃_{_}_{(p, V-1)} “0” is input is unlighted.

In FIG. 31, the fourth sub-pixels 49W are unlighted. Therefore, an input signal value x₄_{_}_{(p, q)} to be input to an arbitrary fourth sub-pixel 49W_{(p, q)} is 0.

In the example illustrated in FIG. 31, an input signal value x₁_{_}_{(p, v}) of the first sub-pixel 49R_{(p, V)} is 220, an input signal value x₂_{_}_{(p, V)} of the second sub-pixel 49G_{(p, V)} is 64, and an input signal value x₃_{_}_{(p, V)} of the third sub-pixel 49B_{(p, V)} is 64 in the boundary section 46 on the display region 45s side. The first sub-pixel 49R_{(p, V)} to which the input signal value x₁_{_}_{(p, V)} “220” is input is lighted in halftone luminance. The second sub-pixel 49G_{(p, V)} to which the input signal value x₂_{_}_{(p, V)} “64” is input is lighted in halftone luminance. The third sub-pixel 49B_{(p, V)} to which the input signal value x₃_{_}_{(p, V)} “64” is input is lighted in halftone luminance.

In this way, by inputting the input signal value x that causes the sub-pixel to be lighted in halftone luminance to the first sub-pixel 49R_{(p, V)}, the second sub-pixel 49G_{(p, V)}, and the third sub-pixel 49B_{(p, V)}, which are the sub-pixels of the pixel 48_{(p, V)} in the boundary section 46, the first sub-pixel 49R_{(p, V)}, the second sub-pixel 49G_{(p, V)}, and the third sub-pixel 49B_{(p, V)} can be lighted in a halftone manner.

Further, the input signal value x₁_{_}_{(p, V)}, the input signal value x₂_{_}_{(p, V)}, and the input signal value x₃_{_}_{(p, V)} are preferably input in consideration of the sub-pixels that are originally supposed to be lighted and the sub-pixels that are originally supposed to be unlighted. That is, the first sub-pixel 49R_{(p, V)} is originally supposed to be fully lighted, in other words, an input signal value x₁_{_}_{(p, V)} “255” is input thereto. The second sub-pixel 49G_{(p, V)} is originally supposed to be unlighted, in other words, an input signal value x₂_{_}_{(p, V)} “0” is input thereto. The third sub-pixel 49B_{(p, V)} is originally supposed to be unlighted, in other words, an input signal value x₃_{_}_{(p, V)} “0” is input thereto. In view of the foregoing, the input signal value x for causing the sub-pixel to be lighted in a halftone manner is preferably input in consideration of the input signal value x that is originally supposed to be input.

Similarly, in the example illustrated in FIG. 31, an input signal value x₁_{_}_{(p, V+1)} of the first sub-pixel 49R_{(p, V+1)} is 64, an input signal value x₂_{_}_{(p, V+1)} of the second sub-pixel 49G_{(p, v+1)} is 64, and an input signal value x₃_{_}_{(p, V+1)} of the third sub-pixel 49B_{(p, V+1)} is 220 in the boundary section 46 on the display region 45t side. In this way, by inputting the input signal value x that causes the sub-pixel to be lighted in halftone luminance to the first sub-pixel 49R_{(p, V+1)}, the second sub-pixel 49G_{(p, V+1)}, and the third sub-pixel 49B_{(p, V+1)}, which are the sub-pixels of the pixel 48_{(p, V+1)} in the boundary section 46 on the display region 45t side, the first sub-pixel 49R_{(p, V+1)}, the second sub-pixel 49G_{(p, V+1)}, and the third sub-pixel 49B_{(p, V+1)} can be lighted in a halftone manner.

As described above, the sub-pixels 49 in the boundary section 46 are lighted in a halftone manner, and thus the luminance change in the boundary section can be reduced.

In FIG. 31, the input signal values x that cause the sub-pixels to be lighted in halftone luminance are “220” and “64”. However, these values are mere examples. The input signal value x may be any value as long as the value causes the sub-pixel to be lighted in halftone luminance.

As described in the first embodiment and the first and second modifications thereof, by setting the signal values such that the input signal value x of the sub-pixel that is originally supposed to be fully lighted becomes larger than the input signal value x of the sub-pixel that is originally supposed to be unlighted, the luminance difference between the boundary section 46 and the display regions other than the boundary section 46 can be further reduced.

In the pixel 48_{(p, V+2)} not included in the boundary section 46 on the display region 45t side, the third sub-pixel 49B_{(p, V+2)} to which the input signal value x₃_{_}_{(p, V+2)} “255” is input is fully lighted. Meanwhile, the first sub-pixel 49R_{(p, V+2)} to which the input signal value x₁_{_}_{(p, V+2)} “0” is input is unlighted. The second sub-pixel 49G_{(p, V+2)} to which the input signal value x₂_{_}_{(p, V+2)} “0” is input is unlighted.

As described using FIG. 31, in the boundary section 46, the input signal value to cause the sub-pixels that are originally supposed to be unlighted to display in a halftone manner is input thereto. Further, the input signal value to cause the sub-pixels that are originally supposed to be fully lighted to display in a halftone manner is also input thereto. Accordingly, the luminance change in the boundary section, and the luminance change between the boundary section and the display regions other than the boundary section are reduced, which prevents the streak from being visually recognized.

As described above, the visibility of a display image can be improved.

In the fourth modification, an example of displaying red in the display region 45s and blue in the display region 45t has been described. However, similar effect can be obtained if the colors to be displayed are reversed. That is, the visual recognition of the streak can be prevented, and the visibility of a display image can be improved even in a case where blue is displayed in the display region 45s and red is displayed in the display region 45t. Further, as described above, the same applies to cases where other primary colors, complementary colors of primary colors, and a primary color and its complementary color are displayed.

Especially, as a combination of colors in the display region 45s (upper side) and the display region 45t (lower side), a combination of red (R) and blue (B), that of blue (B) and red (R), that of blue (B) and green (B), and that of green (B) and blue (B) provide significant effects.

The present modification is applicable to a configuration having three or more display regions, as described in the first embodiment.

The present modification is applicable to the first embodiment, the first to third modifications thereof, and other embodiments described below. That is, the display regions in single colors may be longitudinally and laterally arranged in plan view, and the pixels in the boundary section may be lighted in a halftone manner.

### Second Embodiment

In a second embodiment, an example will be described in which in a display panel that displays a plurality of display regions in single colors adjacent to one another, pixels are caused to display in a halftone manner only in one display region, in a boundary section of adjacent display regions.

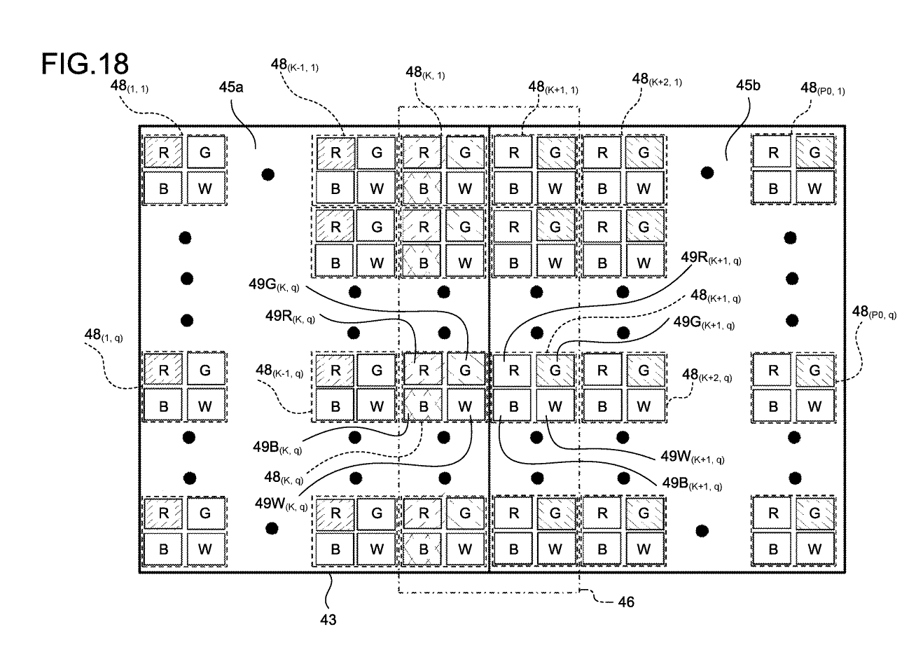

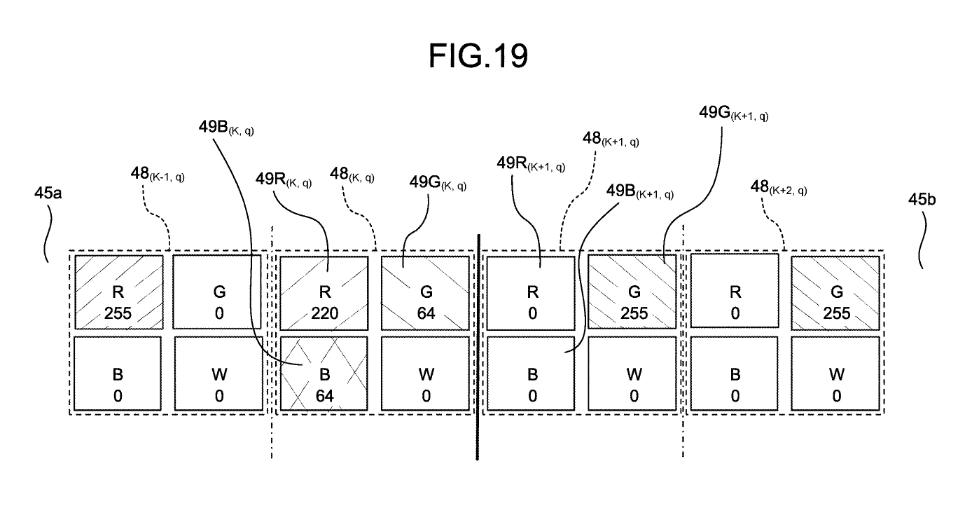

The second embodiment will be described with reference to FIGS. 18 and 19.

In the first embodiment, the example of causing both the pixel 48_{(S, q)} on the display region 45a-side and the pixel 48_{(S+1, q)} on display region 45b-side of the boundary section 46 to display in a halftone manner has been described. In the second embodiment, an example will be described in which one pixel on the display region 45a side or the display region 45b side is caused to display in a halftone manner, and the other pixel is left in its original state, i.e., a lighted or unlighted state without causing the pixel to display in a halftone manner.

FIG. 18 illustrates an example of displaying red and green adjacent to each other as single colors, similarly to the first embodiment. In FIG. 18, assume that in a boundary section 46 of the display region 45a where red is displayed and the display region 45b where green is displayed, a pixel 48_{(1, q)} on a K-th column on the display region 45a side and a pixel 48_{(K+1, q)} on a (K+1)-th column on the display region 45b side are adjacent to each other (K is an integer of 2 or more, and (P₀−2) or less).

Regarding pixels 48 not included in the boundary section 46, the first sub-pixels 49R are fully lighted, and the second sub-pixels 49G, the third sub-pixels 49B, and the fourth sub-pixels 49W are unlighted in a pixel 48_{(1, q)} to a pixel 48_{(K-1, q)} in the display region 45a. Similarly, regarding the pixels 48 not included in the boundary section 46, the second sub-pixels 49G are fully lighted, and the first sub-pixels 49R, the third sub-pixels 49B, and the fourth sub-pixels 49W are unlighted in a pixel 48_{(K+2, q)} to a pixel 48 _{(P0, q)} in the display region 45b.

In the boundary section 46, only the pixel 48_{(K, q)} on the display region 45a side is lighted in a halftone manner, and the pixel 48_{(K+1, q)} on the display region 45b side is lighted in the same manner as the pixels not included in the boundary section 46. In a case where a pixel lighted in a halftone manner is the pixel 48_{(K+1, q)} on the display region 45b side, and a pixel lighted in the same manner as the pixels not included in the boundary section 46 is the pixel 48_{(1, q)} on the display region 45a side, the pixel 48_{(K, q)} and the pixel 48_{(K+1, q)} may just be interpreted the other way around.

For example, on a q-th row in the boundary section 46, a second sub-pixel 49G_{(K, q)} and a third sub-pixel 49B_{(K, q)} of the pixel 48_{(K, q)} on the display region 45a side, which are originally supposed to be unlighted, are lighted in a halftone manner.

Further, a first sub-pixel 49R_{(K, q)} of the pixel 48_{(K, q)} on the display region 45a side, which is originally supposed to be fully lighted, is lighted in a halftone manner.

Meanwhile, a second sub-pixel 49G_{(K+1, q)} is fully lighted, and a first sub-pixel 49R_{(K+1, q)} and a third sub-pixel 49B_{(1, K+1)} are unlighted, in the pixel 48_{(K+1, q)} on the display region 45b side, in the same manner as the pixels 48 in the regions other than the boundary section 46.

In FIG. 18, the fourth sub-pixels 49W are unlighted.

In a case where one pixel (the pixel 48_{(K, q)} in FIG. 18) of the two pixels in the boundary section 46 is lighted in a halftone manner, a luminance difference between the pixel 48_{(K, q)} lighted in a halftone manner, and the pixel 48_{(K+1, q)} lighted in a single color (green in FIG. 18) is small. Therefore, luminance change in the boundary section 46 can be reduced according to the second embodiment.

The luminance change is reduced between the pixel 48 in the boundary section 46, and the pixel 48 that is not included in the boundary section 46 and that is adjacent to the boundary section 46. For example, in the display region 45a, the pixel 48_{(K, q)} is lighted in a halftone manner, and the pixel 48_{(K-1, q)} is lighted in the single color between the pixel 48_{(K, q)} in the boundary section 46, and the pixel 48_{(K-1, q)} adjacent to the pixel 48_{(K, q)}. Accordingly, the luminance change in the boundary section 46 and the regions other than the boundary section 46 is reduced.

Accordingly, the luminance change in the boundary section 46, and the luminance change between the boundary section and the display regions other than the boundary section are reduced, which prevents a streak in the boundary section from being visually recognized.

In this way, the sub-pixels that are originally supposed to be unlighted are lighted in a halftone manner, and the sub-pixels that are originally supposed to be fully lighted are also lighted in a halftone manner. Therefore, the luminance change is reduced, which prevents the streak from being visually recognized. As described above, the visibility of a display image can be improved.

FIG. 19 is an enlarged view of the pixels on the q-th row near the boundary section 46 in FIG. 18.

A first sub-pixel 49R_{(K-1, q)} to which an input signal value x₁_{_}_{(K-1, q)} “255” is input is fully lighted. Meanwhile, a second sub-pixel 49G_{(K-1, q)} to which an input signal value x₂_{_}_{(K-1, q)} “0” is input is unlighted. A third sub-pixel 49B_{(K-1, q)} to which an input signal value x₃_{_}_{(K-1, q)} “0” is input is unlighted.

In FIG. 19, the fourth sub-pixels 49W are unlighted. Therefore, an input signal value x₄_{_}_{(p, q)} to be input to an arbitrary fourth sub-pixel 49W_{(p, q)} is 0.

In the example illustrated in FIG. 19, an input signal value x₁_{_}_{(K, q)} of the first sub-pixel 49R_{(K, q)} is 220,an input signal value x₂_{_}_{(K, q)} of the second sub-pixel 49G_{(K, q)} is 64, and an input signal value x₃_{_}_{(K, q)} of the third sub-pixel 49B_{(K, q)} is 64 in the boundary section 46 on the display region 45a side. The first sub-pixel 49R_{(K, q)} to which the input signal value x_{q}_{_}_{(K, q)} “220” is input is lighted in halftone luminance. The second sub-pixel 49G_{(K, q)} to which the input signal value x₂_{_}_{(K, q)} “64” is input is lighted in halftone luminance. The third sub-pixel 49B_{(K, q)} to which the input signal value x₃_{_}_{(K, q)} “64” is input is lighted in halftone luminance.

In this way, by inputting the input signal value x that causes the sub-pixel to be lighted in halftone luminance to the first sub-pixel 49R_{(K, q)}, the second sub-pixel 49G_{(K, q)}, and the third sub-pixel 49B_{(K, q)}, which are the sub-pixels of the pixel 48_{(K, q)} in the boundary section 46, the first sub-pixel 49R_{(K, q)}, the second sub-pixel 49G_{(K, q)}, and the third sub-pixel 49B_{(K, q)} can be lighted in a halftone manner.

Further, the input signal value x₁_{_}_{(K, q)}, the input signal value x₂_{_}_{(K, q)}, and the input signal value x₃_{_}_{(K, q)} are preferably input in consideration of the sub-pixels that are originally supposed to be lighted and the sub-pixels that are originally supposed to be unlighted. That is, the first sub-pixel 49R_{(K, q)} is originally supposed to be fully lighted, in other words, an input signal value x₁_{_}_{(K, q)} “255” is input thereto. The second sub-pixel 49G_{(K, q)} is originally supposed to be unlighted, in other words, an input signal value x₂_{_}_{(K, q)} “0” is input thereto. The third sub-pixel 49B_{(K, q)} is originally supposed to be unlighted, in other words, an input signal value x₃_{_}_{(K, q)} “0” is input thereto. In view of the foregoing, the input signal value x for causing the sub-pixel to be lighted in a halftone manner is preferably input in consideration of the input signal value x that is originally supposed to be input. The input signal values x of the sub-pixels 49 in different colors that are originally supposed to be unlighted may be the same or may be different.

In the example illustrated in FIG. 19, an input signal value x₁_{_}_{(K+1, q)} of the first sub-pixel 49R_{(K+}^{1, q)} is 0, an input signal value x₂_{_}_{(K+1, q)} of the second sub-pixel 49G_{(K+1, q)} is 255, and an input signal value x₃_{_}_{(K+1, q)} of the third sub-pixel 49B_{(K+1, q)} is 0 in the boundary section 46 on the display region 45b side.

As described above, one pixel of the two pixels in the boundary section 46 is lighted in a halftone manner, whereby the luminance change in the boundary section can be reduced.

In FIG. 19, the input signal values x that cause the sub-pixels to be lighted in halftone luminance are “220” and “64”. However, these values are mere examples. The input signal value x may be any value as long as the value causes the sub-pixel to be lighted in halftone luminance.

As described in the first embodiment and the first to third modifications thereof, by setting the signal values such that the input signal value x of the sub-pixel that is originally supposed to be fully lighted becomes larger than the input signal value x of the sub-pixel that is originally supposed to be unlighted, the luminance difference between the boundary section 46 and the display regions other than the boundary section 46 can be further reduced.

In the pixel 48_{(K+2, q)} not included in the boundary section 46 on the display region 45b side, an input signal value x₁_{_}_{(K+2, q)}, an input signal value x₂_{_}_{(K+2, q)}, and an input signal value x₃_{_}_{(K+2, q)} are the same as the input signal value x₁_{_}_{(K+1, q)}, the input signal value x₂_{_}_{(K+1, q)}, and the input signal value x₃_{_}_{(K+1, q)}, respectively.

As described with reference to FIG. 19, in the pixels of one column of the boundary section 46, the input signal value x to cause the sub-pixels 49 that are originally supposed to be unlighted to display in a halftone manner is input thereto. Further, the input signal value x to cause the sub-pixels 49 that are originally supposed to be fully lighted to display in a halftone manner is input thereto. Accordingly, the luminance change in the boundary section 46, and the luminance change between the boundary section 46 and the display regions other than the boundary section 46 are reduced, which prevents the streak from being visually recognized.

Further, in the pixels 48 in the column to be lighted in a halftone manner in the boundary section 46, the input signal value x to be input to the sub-pixel 49 that is originally supposed to be fully lighted is preferably made larger than the input signal value x to be input to the sub-pixel 49 that is originally supposed to be unlighted. By setting the input signal values x in this way, the luminance change between the pixels 48 in the columns to be lighted in a halftone manner in the boundary section 46, and the pixels 48 in the display regions other than the aforementioned display regions can be further reduced.

As described above, the visibility of a display image can be improved.

The second embodiment is applicable to the case of displaying the single colors as primary colors adjacent to each other, described in the first embodiment and the first modification thereof, the case of displaying the single colors as complementary colors of primary colors adjacent to each other, described in the second modification of the first embodiment, and the case of displaying the single colors as a primary color and its complementary color, described in the third modification of the first embodiment.

### Third Embodiment

In a third embodiment, an example to turn on a sub-pixel that displays white, in addition to sub-pixels that are originally supposed to be fully lighted, in a boundary section where single colors are displayed adjacent to each other, will be described.

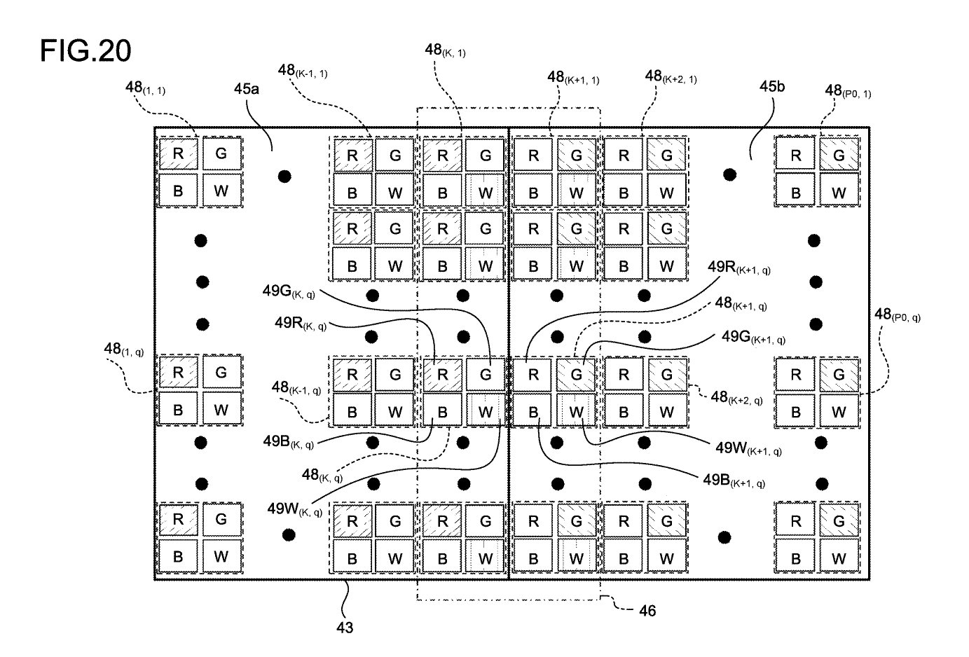

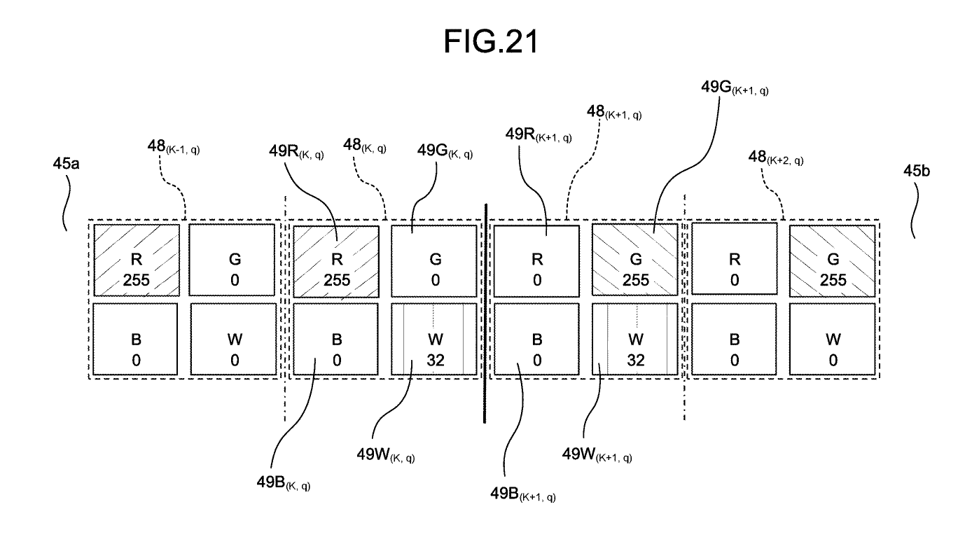

The present embodiment will be described with reference to FIGS. 20 and 21.

FIG. 20 illustrates an example of displaying red and green adjacent to each other as single colors, similarly to the first embodiment. In FIG. 20, assume that in a boundary section 46 of a display region 45a where red is displayed and a display region 45b where green is displayed, a pixel 48_{(K, q)} on a K-th column on the display region 45a side and a pixel 48_{(K+1, q)} on a (K+1)-th column on the display region 45b side are adjacent to each other (K is an integer of 2 or more, and (P₀−2) or less).

In the present embodiment, regarding pixels 48 not included in the boundary section 46, the first sub-pixels 49R are fully lighted, and the second sub-pixels 49G, the third sub-pixels 49B, and the fourth sub-pixels 49W are unlighted in a pixel 48_{(1, q)} to a pixel 48_{(K-1, q)} in the display region 45a. Similarly, regarding the pixels 48 not included in the boundary section 46, the second sub-pixels 49G are fully lighted, and the first sub-pixels 49R, the third sub-pixels 49B, and the fourth sub-pixels 49W are unlighted in a pixel 48_{(K+2, q)} to a pixel 48_{(P0, q)} in the display region 45b.

In the boundary section 46, a first sub-pixel 49R_{(K, q)} is fully lighted and a fourth sub-pixel 49W_{(K, q)} is lighted in a halftone manner in the pixel 48_{(K, q)} on the display region 45a side. A second sub-pixel 49G_{(K, q)} and a third sub-pixel 49B_{(K, q)} are unlighted.

Similarly, in the boundary section 46, a second sub-pixel 49G_{(K+q)} is fully lighted and a fourth sub-pixel 49W_{(K+1, q)} is lighted in a halftone manner in the pixel 48_{(K+1, q)} on the display region 45b side. A first sub-pixel 49R_{(K+1, q)} and a third sub-pixel 49B_{(K+1, q)} are unlighted.

As illustrated in FIGS. 4 to 6 of the first embodiment, a black streak occurs between the display regions 45a and 45b where single colors are displayed. Therefore, as described in the present embodiment, the fourth sub-pixels 49W in the boundary section 46, where the black streak occurs, are lighted in a halftone manner, whereby luminance in the boundary section 46 can be increased. Accordingly, occurrence of the black streak can be prevented, and the visibility of a display image can be improved.

FIG. 21 is an enlarged view of the pixels on a q-th row near the boundary section 46 in FIG. 20.

A first sub-pixel 49R_{(K-1, q)} to which an input signal value x₁_{_}_{(K-1, q)} “255” is input is fully lighted. Meanwhile, a second sub-pixel 49G_{(K-1, q)} to which an input signal value x₂_{_}_{(K-1, q)} “0” is input is unlighted. A third sub-pixel 49B_{(K-1, q)} to which an input signal value x₃_{_}_{(K-1, q)} “0” is input is unlighted. A fourth sub-pixel 49W_{(K-1, q)} to which an input signal value x₄_{_}_{(K-1, q)} “0” is input is unlighted.

In the example illustrated in FIG. 21, an input signal value x₁_{_}_{(K, q)} of the first sub-pixel 49R_{(K, q)} is 255, an input signal value x₂_{_}_{(K, q)} of the second sub-pixel 49G_{(K, q)} is 0, an input signal value x₃_{_}_{(K, q)} of the third sub-pixel 49B_{(K, q)} is 0, and an input signal value x₄_{_}_{(K, q)} of the fourth sub-pixel 49W_{(K, q)} is 32 in the boundary section 46 on the display region 45a side. The fourth sub-pixel 49W_{(K, q)} to which the input signal value x₄_{_}_{(K, q)} “32” is input is lighted in halftone luminance between an unlighted state and a fully lighted state.

In the example illustrated in FIG. 21, an input signal value x₁_{_}_{(K+1, q)} of the first sub-pixel 49R_{(K+1, q)} is 0, an input signal value x₂_{_}_{(K+1, q)} of the second sub-pixel 49G_{(K+1, q)} is 255, an input signal value x₃_{_}_{(K+1, q)} of the third sub-pixel 49B_{(K+1, q)} is 0, and an input signal value x₄_{_}_{(K+1, q)} of the fourth sub-pixel 49W_{(K+1, q)} is 32 in the boundary section 46 on the display region 45b side.

In FIG. 21, the input signal value x that causes the sub-pixel to be lighted in halftone luminance is “32”.

However, this is a mere example. The input signal value x may be any value as long as the value causes the sub-pixel to be lighted in halftone luminance.

In the pixel 48_{(K+2, q)} not included in the boundary section 46 on the display region 45b side, an input signal value x₁_{_}_{(K+2}, q) “0” is input to a first sub-pixel 49R_{(K+2, q)} to be unlighted. An input signal value x₂_{_}_{(K+2, q)} “255” is input to a second sub-pixel 49G_{(K+2, q)} to be fully lighted. An input signal value x₃_{_}_{(K+2, q)} “0” is input to a third sub-pixel 49B_{(K+2, q)} to be unlighted. An input signal value x₄_{_}_{(K+2, q)} “0” is input to a fourth sub-pixel 49W_{(K+2, q)} to be unlighted.

As described above, according to the present embodiment, occurrence of the streak is prevented, and the visibility of a display image can be improved.

The third embodiment is applicable to the case of displaying the single colors as primary colors adjacent to each other, described in the first embodiment, the case of displaying the single colors as complementary colors of primary colors adjacent to each other, described in the second modification of the first embodiment, and the case of displaying the single colors as a primary color and its complementary color, described in the third modification of the first embodiment.

The third embodiment can be applied to the second embodiment. That is, the sub-pixels that display white are lighted in a halftone manner in either one of the adjacent display regions that display the single colors, whereby occurrence of the streak is prevented, and the visibility of a display image can be improved.

### Fourth Embodiment

In a fourth embodiment, an example of turning on a sub-pixel that displays white, in a boundary section where single colors are displayed adjacent to each other, will be described.

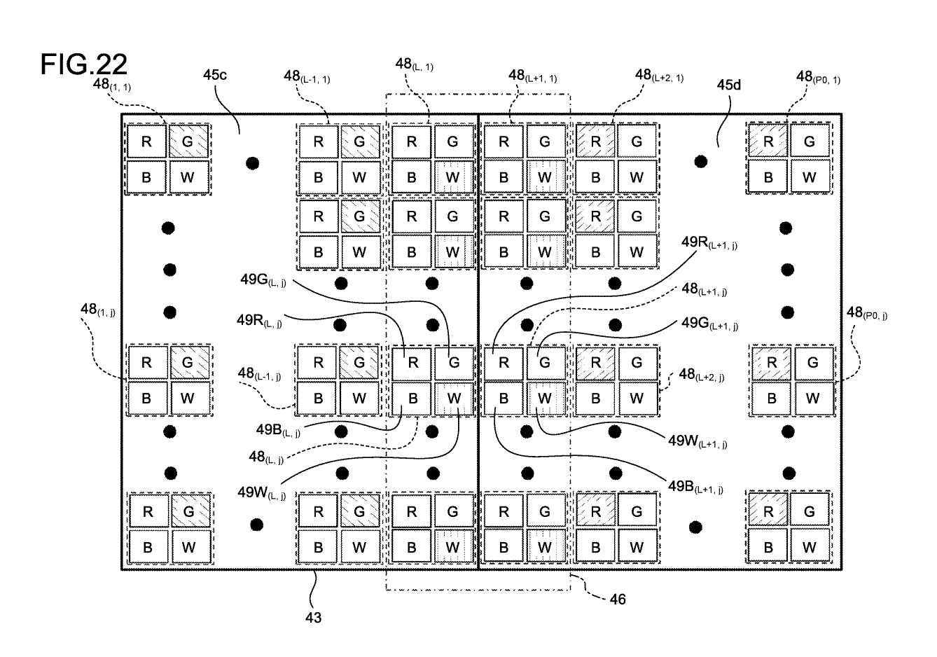

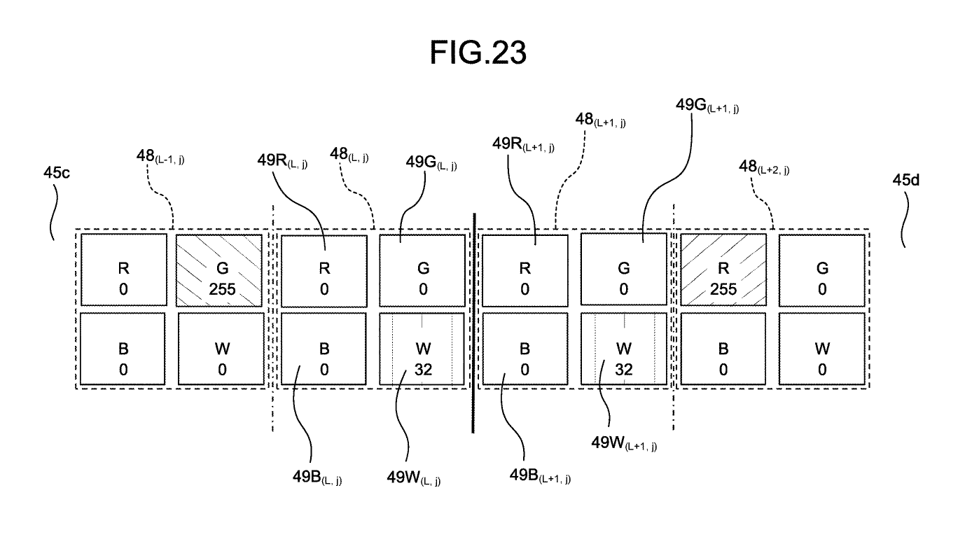

The present embodiment will be described with reference to FIGS. 22 and 23.

FIG. 22 illustrates an example of displaying green and red adjacent to each other as single colors, similarly to the first modification of the first embodiment. In FIG. 22, assume that in a boundary section 46 of a display region 45c where green is displayed and a display region 45d where red is displayed, a pixel 48_{(L, j)} on an L-th column on the display region 45c side, and a pixel 48_{(L+1, j)} on an (L+1)-th column on the display region 45d side are adjacent to each other (L is an integer of 2 or more, and (P₀−2) or less, and j is an integer of (Q₀−1) or less).

In the present embodiment, regarding pixels 48 not included in the boundary section 46, the second sub-pixels 49G are fully lighted, and the first sub-pixels 49R, the third sub-pixels 49B, and the fourth sub-pixels 49W are unlighted in a pixel 48_{(1, j)} to a pixel 48_{(L-1, j)} in the display region 45c. Similarly, regarding the pixels 48 not included in the boundary section 46, the first sub-pixels 49R are fully lighted, and the second sub-pixels 49G, the third sub-pixels 49B, and the fourth sub-pixels 49W are unlighted in a pixel 48_{(L+2, j)} to a pixel 48_{(P0, j)} in the display region 45d.

In the pixel 48_{(L, j)} on the display region 45c side, only a fourth sub-pixel 49W_{(L, j)} is lighted in a halftone manner, and a first sub-pixel 49R_{(L, j)}, a second sub-pixel 49G_{(L, j)}, and a third sub-pixel 49B_{(L, j)} are unlighted.

Similarly, in the boundary section 46, in the pixel 48_{(L+j)} on the display region 45f side, only a fourth sub-pixel 49W_{(L+j)} is lighted in a halftone manner, and a first sub-pixel 49R_{(L+1, j)} a second sub-pixel 49G_{(L+1, j)}, and a third sub-pixel 49B_{(L+1, j)} are unlighted.

As illustrated in FIGS. 7 to 9 of the first embodiment, a bright streak occurs between the display regions 45c and 45d where the single colors are displayed. Therefore, as described in the present embodiment, the first sub-pixels 49R to the third sub-pixels 49B including the sub-pixels that display the single colors are unlighted. Instead, to compensate luminance, the fourth sub-pixels 49W that display white are lighted in a halftone manner.

As described above, according to the present embodiment, occurrence of the streak is prevented, and the visibility of a display image can be improved.

FIG. 23 is an enlarged view of the pixels on a j-th row near the boundary section 46 of FIG. 22.

A second sub-pixel 49G_{(L-j)} to which an input signal value x₂_{_}_{(L-1, j)} “255” is input is fully lighted. Meanwhile, a first sub-pixel 49R_{(L-1, j)} to which an input signal value x₁_{_}_{(L-1, j)} “0” is input is unlighted. A third sub-pixel 49B_{(L-1, j)} to which an input signal value x₃_{_}_{(L-1, j)} “0” is input is unlighted. A fourth sub-pixel 49W_{(L-j)} to which an input signal value x₄_{_}_{(L-1, j)} “0” is input is unlighted.

In the example illustrated in FIG. 23, an input signal value x₁_{_}_{(L, j)} of the first sub-pixel 49R_{(L, j)} is 0, an input signal value x₂_{_}_{(L, j)} of the second sub-pixel 49G_{(L, j)} is 0,an input signal value x₃_{_}_{(L, j)} of the third sub-pixel 49B_{(L, j)} is 0, and an input signal value x₄_{_}_{(L, j)} of the fourth sub-pixel 49W_{(L, j)} is 32 in the boundary section 46 on the display region 45c side. The fourth sub-pixel 49W_{(L, j)} to which the input signal value x₄_{_}_{(L, j)} “32” is input is lighted in halftone luminance.

In the example illustrated in FIG. 23, an input signal value x₁_{_}_{(L+1, j)} of the first sub-pixel 49R_{(L+1, j)} is 0, an input signal value x₂_{_}_{(L+1, j)} of the second sub-pixel 49G_{(L+1, j)} is 0, an input signal value x₃_{_}_{(L+1, j)} of the third sub-pixel 49B_{(L+1, j)} is 0, and an input signal value x₄_{_}_{(L+1, j)} of the fourth sub-pixel 49W_{(L+1, j)} is 32 in the boundary section 46 on the display region 45d side.

In FIG. 23, the input signal value x that causes the sub-pixel to be lighted in halftone luminance is “32”. However, this is a mere example. The input signal value x may be any value as long as the value causes the sub-pixel to be lighted in halftone luminance.

In the pixel 48_{(L+2, j)} not included in the boundary section 46 on the display region 45d side, an input signal value x₁_{_}_{(L+2, j)} “255” is input to a first sub-pixel 49R_{(L+2, j} to be fully lighted. An input signal value x₂_{_}_{(L+2, j)} “0” is input to a second sub-pixel 49G_{(L+2, j)} to be unlighted. An input signal value x₃_{_}_{(L+2, j)} “0” is input to a third sub-pixel 49B_{(L+2, j)} to be unlighted. An input signal value x₄_{_}_{(L+2, j)} “0” is input to a fourth sub-pixel 49W_{(L+2, j)} to be unlighted.

According to the present embodiment, occurrence of the streak is prevented, and the visibility of a display image can be improved.

The fourth embodiment is applicable to the case of displaying the single colors as primary colors adjacent to each other, described in the first modification of the first embodiment, the case of displaying the single colors as complementary colors of primary colors adjacent to each other, described in the second modification of the first embodiment, and the case of displaying the single colors as a primary color and its complementary color, described in the third modification of the first embodiment.

The fourth embodiment can be applied to the second embodiment. That is, the sub-pixels that display white are lighted in a halftone manner in either one of the adjacent display regions that display the single colors, whereby occurrence of the streak is prevented, and the visibility of a display image can be improved.

### Modification of Fourth Embodiment

In a modification of the fourth embodiment, an example to rearrange sub-pixels, and turn on sub-pixels that display white among the rearranged sub-pixels, in a boundary section where single colors are displayed adjacent to each other, will be described.

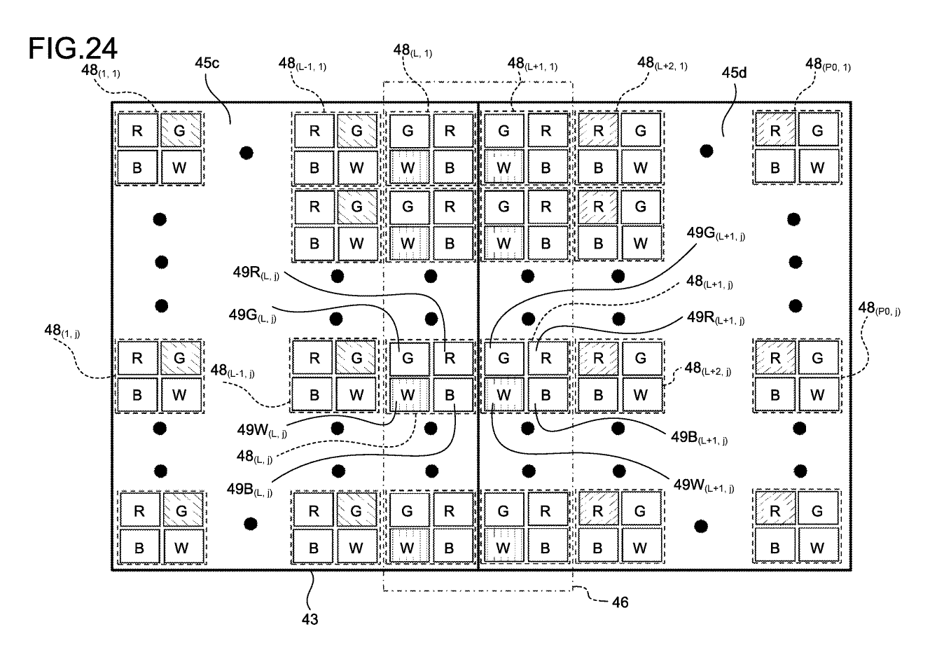

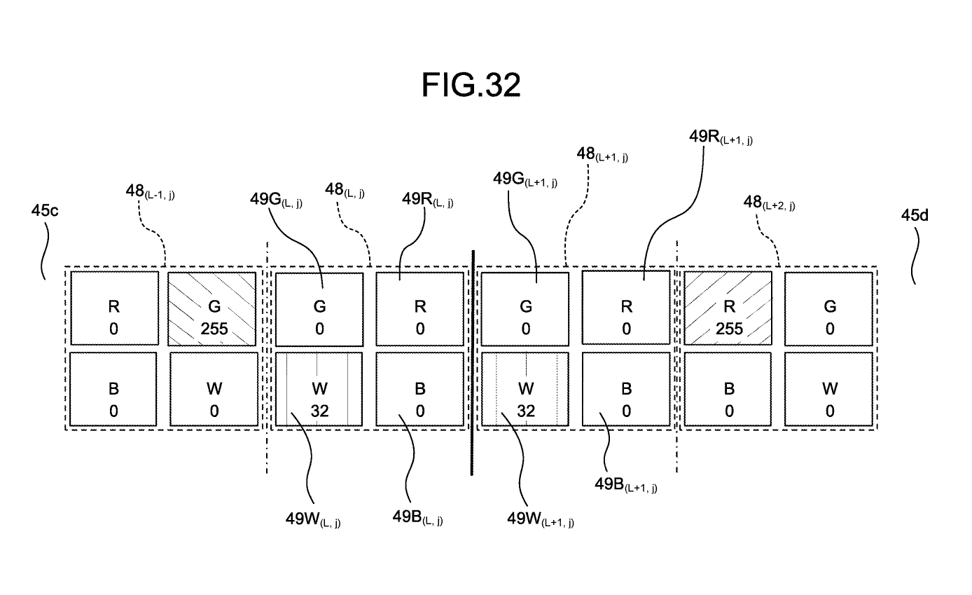

The present embodiment will be described with reference to FIGS. 24 and 32.

As illustrated in FIG. 24, in the present modification, in regions other than the boundary section 46, the first sub-pixel 49R, the second sub-pixel 49G, the third sub-pixel 49B, and the fourth sub-pixel 49W are arranged at positions of upper left, upper right, lower left, and lower right, respectively, in the pixel 48. In the present modification, the second sub-pixel 49G, the first sub-pixel 49R, the fourth sub-pixel 49W, and the third sub-pixel 49B in the pixel 48 in the boundary section 46 are arranged at positions of upper left, upper right, lower left, and lower right, respectively. That is, the sub-pixels in a pixel 48_{(L, j)} and a pixel 48_{(L+1, j)} in the boundary section 46 are symmetrically arranged to the sub-pixels in the pixels 48 in the regions other than the boundary section 46.

FIG. 32 is an enlarged view of the pixels on a j-th row near the boundary section 46 of FIG. 24. Input signal values x to be input to the respective sub-pixels 49 are the same as those in FIG. 24.

According to the present modification, by arranging the fourth sub-pixels 49W in a distributed manner, white displayed by the fourth sub-pixels 49W is not emphasized.

As described above, according to the present modification, occurrence of a streak can be prevented, and the visibility of a display image can be improved.

The modification of the fourth embodiment is applicable to the case of displaying the single colors as primary colors adjacent to each other, described in the first modification of the first embodiment, the case of displaying the single colors as complementary colors of primary colors adjacent to each other, described in the second modification of the first embodiment, and the case of displaying the single colors as a primary color and its complementary color, described in the third modification of the first embodiment.

The modification of the fourth embodiment can be applied to the second embodiment. That is, the sub-pixels that display white are lighted in a halftone manner in either one of the adjacent display regions that display the single colors, whereby occurrence of the streak is prevented, and the visibility of a display image can be improved.

### Fifth Embodiment

In a fifth embodiment, an example of using pixels in different shapes, in place of the square pixels in the first embodiment and the modifications thereof, and the third and fourth embodiments, will be described.

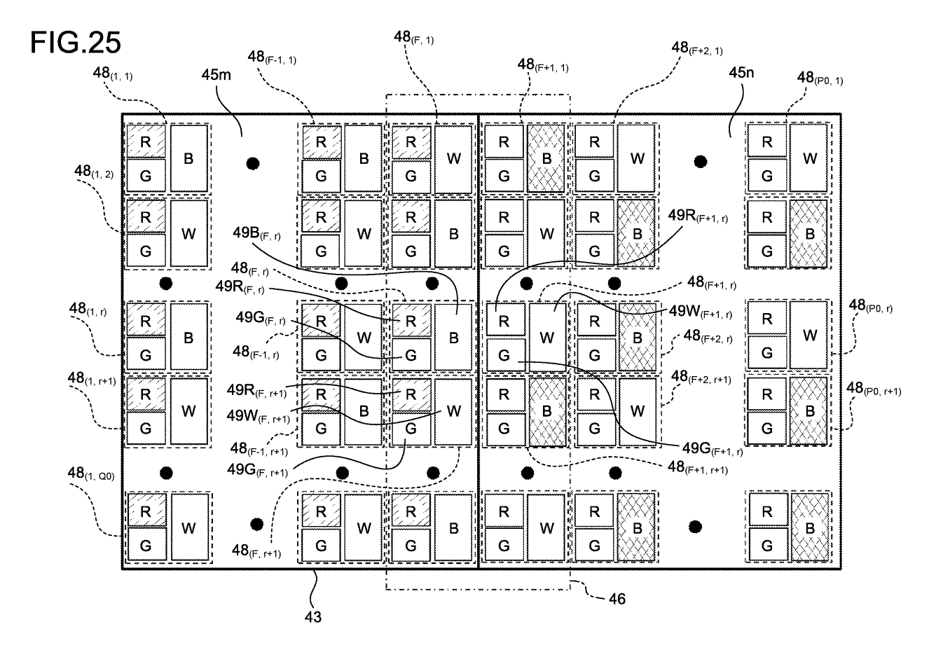

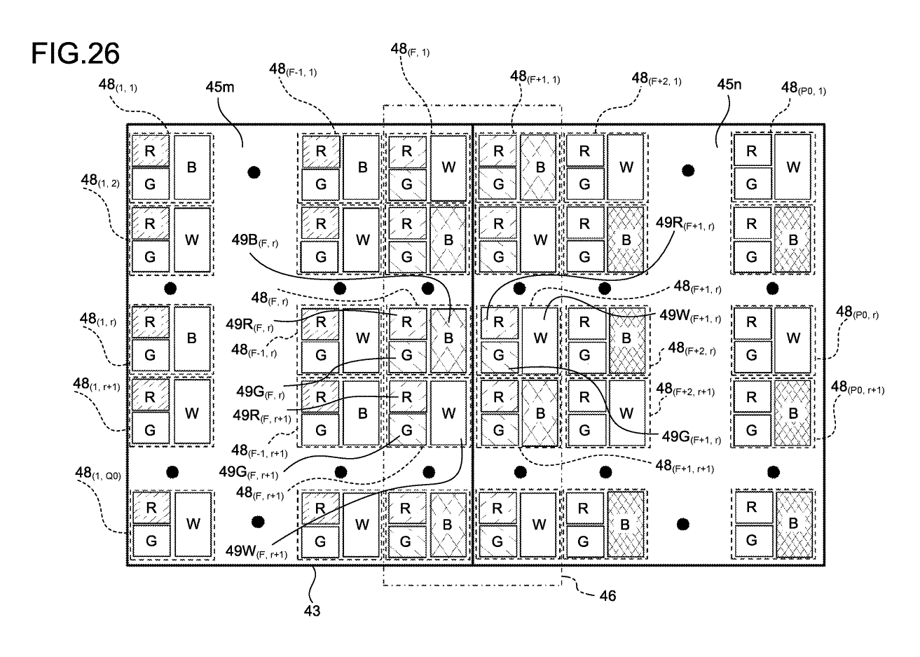

The present embodiment will be described with reference to FIGS. 25 and 26.

FIG. 25 illustrates the shapes of the pixels 48 of the present embodiment. A first sub-pixel 49R_{(F, r)}, a second sub-pixel 49G_{(F, r)}, and a third sub-pixel 49B_{(F, r)} are arranged at positions of upper left, lower left, and right, respectively, in a pixel 48_{(F, r)} on an F-th column and an r-th row (F is an odd number of 1 or more and an integer of (P₀−1) or less, and r is an integer of 2 or more, and (Q₀−2) or less). The area of the third sub-pixel 49B_{(F, r)} is the same as a total of the area of the first sub-pixel 49R_{(F, r)} and the area of the second sub-pixel 49G_{(F, r)}.

In a pixel 48_{(F+1, r)} on an (F+1)-th column, adjacent to an arbitrary pixel 48_{(F, r)}, a first sub-pixel 49R_{(F+1, r)}, a second sub-pixel 49G_{(F+1, r)}, and a fourth sub-pixel 49W_{(F+1, r)} are arranged at positions of upper left, lower left, and right, respectively. The area of the fourth sub-pixel 49W_{(F+r)} is the same as a total of the area of the first sub-pixel 49R_{(F+r)} and the area of the second sub-pixel 49G_{(F+1, r)}.

Arrangement of sub-pixels in a pixel 48_{(F, r+1)} on a (r+1)-th row, adjacent to an arbitrary pixel 48_{(F, r)}, is the same as that of the pixel 48_{(F+1, r)}. That is, in the pixel 48_{(F, r+1)}, a first sub-pixel 49R_{(F, r+1)}, a second sub-pixel 49G_{(F, r+1)}, and a fourth sub-pixel 49W_{(F, r+1)} are arranged at positions of upper left, lower left, and right. The area of the fourth sub-pixel 49W_{(F, r+1)} is the same as a total of the area of the first sub-pixel 49R_{(F, r+1)} and the area of the second sub-pixel 49G_{(F, r+1)}.

As described above, the pixel 48 of the present embodiment includes the third sub-pixel 49B or the fourth sub-pixel 49W having the area that is the total of the area of the first sub-pixel 49R and the area of the second sub-pixel 49G. To be more specific, the first sub-pixel 49R and the second sub-pixel 49G have the same shape and the same area, and each of the third sub-pixel 49B and the fourth sub-pixel 49W has a shape obtained by vertically arranging the first sub-pixel 49R and the second sub-pixel 49G in plan view. The third sub-pixel 49B and the fourth sub-pixel 49W are alternately arranged in pixel rows and in pixel columns, in other words, different colors are adjacent to each other. The pixels having the shapes of the present embodiment are called modified square pixels.

FIG. 25 illustrates a case of performing display in display regions 45m and 45n in different single colors adjacent to each other in a display panel 43. In FIG. 25, for example, red is displayed in the display region 45m and blue is displayed in the display region 45n.

In the display panel 43 in FIG. 25, in a pixel 48_{(1, r)} to a pixel 48_{(F, r)} in the display region 45m, the first sub-pixels 49R are fully lighted, and the second sub-pixels 49G, the third sub-pixels 49B, and the fourth sub-pixels 49W are unlighted. In a pixel 48_{(F+1, r)} to a pixel 48_{(P0, r)} in the display region 45n, the third sub-pixels 49B are fully lighted, and the first sub-pixels 49R, the second sub-pixels 49G, and the fourth sub-pixels 49W are unlighted.

If the sub-pixels are lighted as described above, a black streak may occur in the boundary section 46, similarly to the description of FIGS. 4 to 6.

Such occurrence of the streak can be prevented by application of the first embodiment and the modifications thereof, and the second to fourth embodiments.

FIG. 26 illustrates an example of applying the first embodiment to FIG. 25. In FIG. 26, the first sub-pixels 49R, the second sub-pixels 49G, and the third sub-pixels 49B are lighted in a halftone manner, and the fourth sub-pixels 49W are unlighted in the pixel 48 on the display region 45m side and the pixel 48 on the display region 45n side in the boundary section 46.

The first sub-pixels 49R, the second sub-pixels 49G, and the third sub-pixels 49B are lighted in halftone luminance according to their original lighted and unlighted states. For example, in FIG. 26, in the pixel 48_{(F, r)} on the r-th row on the display region 45m side, by setting an input signal value x to be input to the first sub-pixel 49R_{(F, r)} that is originally supposed to be fully lighted larger than input signal values x to be input to the second sub-pixel 49G_{(F, r)} and the second sub-pixel 49B_{(F, r)} that are originally supposed to be unlighted, the pixels can be lighted in luminance according to their original lighted and lights-out states.

Similarly, for example, in FIG. 26, in the pixel 48_{(F, r+1)} on the (r+1)-th row on the display region 45m side, by setting the input signal value x to be input to the first sub-pixel 49R_{(F, r+1)} that is originally supposed to be fully lighted larger than the input signal value x to be input to the second sub-pixel 49G_{(F, r+1)} that is originally supposed to be unlighted, the pixels can be lighted in luminance according to their original lighted and lights-out states.

The fifth embodiment can be applied to the first to third modifications of the first embodiment, and the second to fourth embodiments.

### Sixth Embodiment

In a sixth embodiment, an example of using pixels in different shapes, in place of the square pixel in the first embodiment and the modifications thereof, and the third and fourth embodiments, and the modified square pixel in the fifth embodiment, will be described.

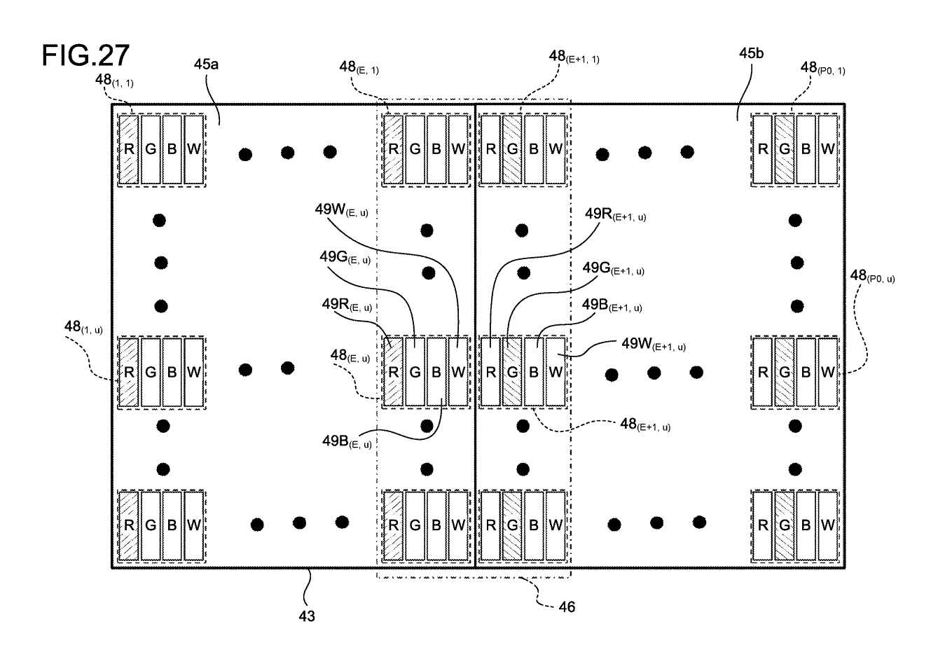

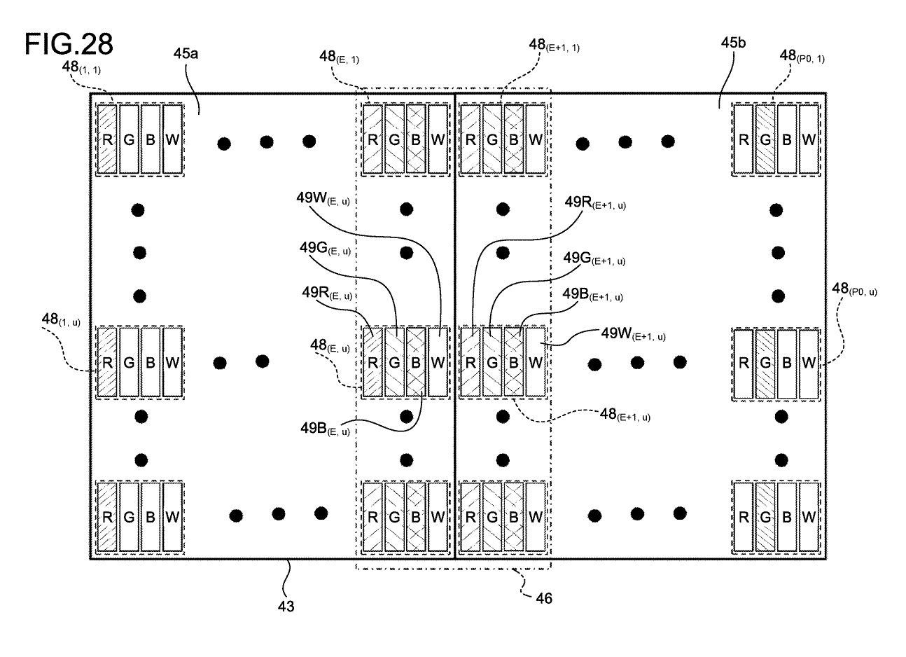

The present embodiment will be described with reference to FIGS. 27 and 28.

FIG. 27 illustrates the shapes of pixels 48 in the present embodiment. In an arbitrary pixel 48_{(E, u)} on an E-th column and a u-th row, a first sub-pixel 49R_{(E, u)}, a second sub-pixel 49G_{(E, u)}, a third sub-pixel 49B_{(E, u)}, and a fourth sub-pixel 49W_{(E, u)} having the same shape and an equal area are laterally arranged (E is an integer of (P₀−1) or less and u is an integer of (Q₀−1) or less). The pixel having the shape of the present embodiment is called a stripe pixel.

FIG. 27 illustrates a case of performing display in display regions 45a and 45b in different single colors laterally adjacent to each other in a display panel 43. In FIG. 27, for example, red is displayed in the display region 45a and green is displayed in the display region 45b.

In the display panel 43 in FIG. 27, the first sub-pixels 49R are fully lighted, and the second sub-pixels 49G, the third sub-pixels 49B, and the fourth sub-pixels 49W are unlighted in a pixel 48_{(1, u)} to a pixel 48_{(E, u)} in the display region 45a. The second sub-pixels 49G are fully lighted, and the first sub-pixels 49R, the third sub-pixels 49B, and the fourth sub-pixels 49W are unlighted in a pixel 48_{(E+1, u)} to a pixel 48_{(P0, u)} in the display region 45b.

If the sub-pixels are lighted as described above, a black streak may occur in a boundary section 46 of the adjacent display regions 45a and 45b.

Such occurrence of the streak can be prevented by application of the first embodiment and the modifications thereof, and the second to fifth embodiments.

FIG. 28 illustrates an example of applying the first embodiment to FIG. 27. In FIG. 28, the first sub-pixels 49R, the second sub-pixels 49G, and the third sub-pixels 49B are lighted in a halftone manner, and the fourth sub-pixels 49W are unlighted in the pixel 48 on the display region 45a and in the pixel 48 on the display region 45b in the boundary section 46.

The first sub-pixels 49R, the second sub-pixels 49G, and the third sub-pixels 49B are lighted in halftone luminance according to their original lighted and unlighted states. For example, in FIG. 28, in the pixel 48_{(E, u)} on the u-th row on the display region 45a side, by setting an input signal value x to be input to the first sub-pixel 49R_{(E, u)} that is originally supposed to be fully lighted larger than input signal values x to be input to the second sub-pixel 49G_{(E, u)} and the second sub-pixel 49B_{(E, u)} that are originally supposed to be unlighted, the pixels can be lighted in luminance according to their original lighted and unlighted states.

Similarly, for example, in FIG. 28, in the pixel 48_{(E+1, u)} on the (E+1)-th column on the display region 45b side, by setting an input signal value x to be input to the second sub-pixel 49G_{(E+1, u)} that is originally supposed to be fully lighted larger than input signal values x to be input to the first sub-pixel 49R_{(E+1, u)} and the second sub-pixel 49B_{(E+1, u)} that are originally supposed be unlighted, the pixels can be lighted in luminance according to their original lighted and unlighted states.

The fifth embodiment can be applied to the first to third modifications of the first embodiment, and the second to fourth embodiments.

The present invention includes the following aspects.

(1) A display device comprising:

a display panel including a plurality of pixels;

at least three of a first sub-pixel in a first color, a second sub-pixel in a second color, a third sub-pixel in a third color, and a fourth sub-pixel in a fourth color, the three sub-pixels being included in each of the pixels; and

a controller configured to input an input signal to the first sub-pixel to the fourth sub-pixel, wherein,

when display is performed in a plurality of display regions in respective single colors adjacent to each other in the display panel, the controller inputs a signal for lighting a sub-pixel that does not contribute to one of the single colors in a halftone manner, in a pixel included in a boundary section of the adjacent display regions.

(2) The display device according to (1), wherein

the controller inputs a signal for lighting a sub-pixel that contributes to one of the single colors in a halftone manner, in the pixel included in the boundary section of the adjacent display regions.

(3) The display device according to (1), wherein

the controller inputs a signal for fully lighting a sub-pixel that contributes to one of the single colors, and a signal for lighting a sub-pixel that does not contribute to one of the single colors and that displays white, in a halftone manner, in the pixel included in the boundary section of the adjacent display regions.

(4) The display device according to any one of (1) to (3), wherein

the controller inputs a signal for lighting a sub-pixel in a halftone manner, in only one display region of the adjacent display regions in the boundary section.

(5) The display device according to any one of (1) to (4), wherein

the single colors displayed in the display regions are primary colors.

(6) The display device according to any one of (1) to (4), wherein

the single colors displayed in the display regions are complementary colors of primary colors.

(7) The display device according to any one of (1) to (4), wherein

the single colors displayed in the display regions are a primary color and a complementary color of the primary color.

(8) The display device according to any one of (1) to (7), wherein

the boundary section of one of the display regions is on a pixel row or a pixel column closest to another one of the display regions adjacent and closest to the one of the display regions.

(9) The display device according to any one of (1) to (8), wherein

the first sub-pixel, the second sub-pixel, the third sub-pixel, and the fourth sub-pixel have a same shape and a same area, and

the first sub-pixel, the second sub-pixel, the third sub-pixel, and the fourth sub-pixel are arranged at positions of upper left, upper right, lower left, and lower right, respectively, in each of the pixels.

(10) The display device according to any one of (1) to (8), wherein

the first sub-pixel and the second sub-pixel have a same shape and a same area,

the third sub-pixel and the fourth sub-pixel each have a shape obtained by vertically arranging the first sub-pixel and the second sub-pixel in plan view, and

the third sub-pixel and the fourth sub-pixel are alternately arranged in pixel rows and in pixel columns.

(11) The display device according to any one of (1) to (8), wherein

the first sub-pixel, the second sub-pixel, the third sub-pixel, and the fourth sub-pixel have a same shape and a same area, and

the first sub-pixel, the second sub-pixel, the third sub-pixel, and the fourth sub-pixel are laterally arranged.

(12) A method of driving a display device including

a display panel including a plurality of pixels, and

at least three of a first sub-pixel in a first color, a second sub-pixel in a second color, a third sub-pixel in a third color, and a fourth sub-pixel in a fourth color, the three sub-pixels being included in each of the pixels, the method comprising:

when display is performed in a plurality of display regions in respective single colors adjacent to each other in the display panel, inputting a signal for lighting a sub-pixel that does not contribute to one of the single colors in a halftone manner, in a pixel included in a boundary section of the adjacent display regions.

What is claimed is:

1. A display device comprising:
a display panel including a plurality of pixels;
at least three of a first sub-pixel in a first color, a second sub-pixel in a second color, a third sub-pixel in a third color, and a fourth sub-pixel in a fourth color, the three sub-pixels being included in each of the pixels; and
a controller configured to input an input signal to the first sub-pixel to the fourth sub-pixel, wherein,
when display is performed in a plurality of display regions in respective single colors adjacent to each other in the display panel, the controller inputs a signal for lighting a sub-pixel that does not contribute to one of the single colors in a halftone manner, in a pixel included in a boundary section of the adjacent display regions.

2. The display device according to claim 1, wherein
the controller inputs a signal for lighting a sub-pixel that contributes to one of the single colors in a halftone manner, in the pixel included in the boundary section of the adjacent display regions.

3. The display device according to claim 1, wherein
the controller inputs a signal for fully lighting a sub-pixel that contributes to one of the single colors, and a signal for lighting a sub-pixel that does not contribute to one of the single colors and that displays white, in a halftone manner, in the pixel included in the boundary section of the adjacent display regions.

4. The display device according to claim 1, wherein
the controller inputs a signal for lighting a sub-pixel in a halftone manner, in only one display region of the adjacent display regions in the boundary section.

5. The display device according to claim 1, wherein
the single colors displayed in the display regions are primary colors.

6. The display device according to claim 1, wherein
the single colors displayed in the display regions are complementary colors of primary colors.

7. The display device according to claim 1, wherein
the single colors displayed in the display regions are a primary color and a complementary color of the primary color.

8. The display device according to claim 1, wherein
the boundary section of one of the display regions is on a pixel row or a pixel column closest to another one of the display regions adjacent and closest to the one of the display regions.

9. The display device according to claim 1, wherein
the first sub-pixel, the second sub-pixel, the third sub-pixel, and the fourth sub-pixel have a same shape and a same area, and
the first sub-pixel, the second sub-pixel, the third sub-pixel, and the fourth sub-pixel are arranged in one of the pixels such that the first sub-pixel and the second sub-pixel are adjacent to each other in a first direction, the third sub-pixel and the fourth sub-pixel are adjacent to each other in the first direction, the first sub-pixel and the third sub-pixel are adjacent to each other in a second direction perpendicular to the first direction, and the second sub-pixel and the fourth sub-pixel are adjacent to each other in the second direction.

10. The display device according to claim 1, wherein
the pixels include a plurality of first pixels, and a plurality of second pixels, each of the first pixels including the first sub-pixel, the second sub-pixel, and the third sub-pixel, and each of the second pixels including the first sub-pixel, the second sub-pixel, and the fourth sub-pixel,
the first pixels and the second pixels are alternately arranged in a first direction, and the first pixels and the second pixels are alternately arranged in a second direction different from the first direction,
the first sub-pixel and the second sub-pixel have a same shape and a same area,
the third sub-pixel and the fourth sub-pixel have a larger area than the first sub-pixel,
in each of the first pixels, the first sub-pixel and the third sub-pixel are adjacent to each other in the first direction, the second sub-pixel and the third sub-pixel are adjacent to each other in the first direction, and the first sub-pixel and the second sub-pixel are adjacent to each other in the second direction, and
in each of the second pixels, the first sub-pixel and the fourth sub-pixel are adjacent to each other in the first direction, the second sub-pixel and the fourth sub-pixel are adjacent to each other in the first direction, and the first sub-pixel and the second sub-pixel are adjacent to each other in the second direction.

11. The display device according to claim 1, wherein
the first sub-pixel, the second sub-pixel, the third sub-pixel, and the fourth sub-pixel have a same shape and a same area, and
the first sub-pixel, the second sub-pixel, the third sub-pixel, and the fourth sub-pixel are arranged in a first direction.

12. A method of driving a display device including
a display panel including a plurality of pixels, and
at least three of a first sub-pixel in a first color, a second sub-pixel in a second color, a third sub-pixel in a third color, and a fourth sub-pixel in a fourth color, the three sub-pixels being included in each of the pixels, the method comprising:
when display is performed in a plurality of display regions in respective single colors adjacent to each other in the display panel, inputting a signal for lighting a sub-pixel that does not contribute to one of the single colors in a halftone manner, in a pixel included in a boundary section of the adjacent display regions.
